(19) United States
(12) Patent Application Publication
(10) Pub. No.: US 2014/0137912 A1
(43) Pub. Date: May 22, 2014

(54) SEGMENTED ADAPTABLE MOBILITY AID DEVICE FOR LEVEL AND INCLINED WALKWAYS AND FOR STAIRS

(71) Applicant: Kevin Roger Kline, Paxinos, PA (US)

(72) Inventor: Kevin Roger Kline, Paxinos, PA (US)

(21) Appl. No.: 13/665,387

(22) Filed: Oct. 31, 2012

Related U.S. Application Data
(63) Continuation-in-part of application No. 12/780,870, filed on May 15, 2010, now Pat. No. 8,302,974.

(51) Int. Cl. A61H 3/00

(52) U.S. Cl. 135/67

(57) ABSTRACT

A segmented adaptable mobility aid device is disclosed that has length-adjustable front and rear legs, a handle, and a knee support platform coupled to the legs and the handle, the legs being adjustable within a range of lengths suitable to straddle steps for ascending and descending stairways, as well as to function on the level, or on a ramp. The lengths of the legs can be adjusted in tandem via single-hand operability of an adjustment mechanism. The knee support platform provides support for an impaired lower leg of a user, not requiring the leg to contact the stairs, and also not requiring the leg to be held mid-air in a hopping motion. The handle enables one-handed use of the segmented adaptable mobility aid device. In some embodiments, spring loaded pins or a pull bar to activate the pins, enable the single-hand operability of the adjustment mechanism.

### CROSS-REFERENCE TO RELATED APPLICATION

This application is a continuation-in-part of application Ser. No. 12/780,870, filed May 15, 2010, and entitled ADAPTABLE MOBILITY AID DEVICE FOR LEVEL AND INCLINED WALKWAYS AND FOR STAIRS, herein incorporated by reference in its entirety.

### TECHNICAL FIELD

This invention relates generally to mobility aid devices, and more particularly to adaptable mobility aid devices.

### BACKGROUND

Reduced mobility is a common plight of individuals with lower leg injuries or individuals who are recovering from lower leg surgery, particularly older individuals. Walkers have been used for decades as aids to improve mobility and sometimes as well to promote healing for leg, ankle, and foot injuries or surgeries. Typically, a walker has four legs with end caps and a structure or frame that surrounds a user's front and sides during use. Some walkers include two or more wheels or casters instead of end caps to make movement of the walker easier. These typical walkers are adequate as walking aids, but in many situations, a user must prevent contact with the floor by an injured foot or ankle. In these circumstances, a user can use only the good leg for bearing weight. Thus, in order to use a typical walker, the user is obliged to use a “step-hop-step-hop- . . . ” gait with the healthier leg, an unnatural and uncomfortable manner of getting around. Furthermore, hopping can be difficult or impossible for some older or heavier individuals.

Besides a user's need to hop, other problems are encountered when using a conventional walker. As a prime example, due to their design for use on level or flat walkways, walkers are generally of little use on stairs. They are unstable and unwieldy on stairs at best, and often cannot be used at all on stairs, due to the distance separating front and rear legs being wider than a typical stair step depth. Moreover, the problem of hopping is exacerbated when the individual using a walker needs to climb or descend stairs. This can happen frequently, since stairs are often encountered when a user visits a doctor's office, a physical therapist, and even in some cases, around the home.

Various attempts have been made to modify walkers for use on stairs. These modified walkers, or other mobility aid devices that can be used on stairs, generally have been unwieldy and/or unsuitable for use on a flat walkway. For example, some mobility aid devices have sets of legs with feet or skids at the bases of the legs with the feet or skids parallel to the forward direction of motion of the walker. These sets of legs and feet are configured to fit on two or three stair steps at a time. Some other devices require a complicated series of adjustments for the leg lengths to accommodate stair riser heights or user height. For example, each leg may require loosening of a threaded key or screw to enable adjustment of the length of that leg, and retightening of the key or screw to prevent subsequent undesired changes in length. Having to do this at the foot of a stairway, and then again at the top of a stairway, can be arduous for someone required to stand on only one leg during the adjustment process.

Some modified walkers have included a pad for support of a user's knee or lower leg during use of the walker. These walkers are either unsuitable for use on stairs, or are difficult to adjust between use on stairs and use on level walkways.

### SUMMARY

A general aspect of the invention is a segmented adaptable mobility aid device. The device includes a plurality of interconnectable segments, each segment having at least one aperture; a pin engageable with the at least one aperture for interconnecting the plurality of interconnectable segments, and for securing the plurality of interconnectable segments against movement relative to each other; and a support platform configured to be coupled to a predetermined segment of the plurality of interconnectable segments, the support platform being for providing knee support or for providing a seat.

In some embodiments, the plurality of interconnectable segments includes a first segment; a second segment configured to engage the first segment; and a third segment configured to engage the second segment. In further embodiments, the device further includes a lever mechanism coupled to the third segment for adjusting the height of the third segment to the height of a stair step or to the incline of a ramp. In yet further embodiments, the lever mechanism comprises a pin and spring arrangement.

In other further embodiments, the first segment is configured to receive the support platform thereon.

In other further embodiments, the first segment includes a handle including a pair of handle arms; and a first pair of legs coupled to respective ones of the pair of handle arms. In still further embodiments, the second segment includes a second pair of legs configured to engage respective ones of the first pair of legs; and a pair of support uprights coupled to the second pair of legs, and configured to engage respective ones of the pair of handle arms. In yet further embodiments, the third segment includes a third pair of legs configured to engage respective ones of the pair of support uprights. In still yet further embodiments, the device further includes a first footer coupled to the second pair of legs for stabilizing the second pair of legs on a surface; and a second footer coupled to the third pair of legs for stabilizing the third pair of legs on the surface.

### BRIEF DESCRIPTION OF THE DRAWINGS

The invention will be more fully understood by reference to the detailed description, in conjunction with the accompanying figures, wherein:

FIG. 1A is an oblique angle view of a preferred embodiment of the present invention in use as an adaptable mobility aid device on a level walkway, showing the device in place in a first position and a knee of a user about to be placed on a knee support platform;

FIG. 1B is an oblique angle view of the preferred embodiment of FIG. 1A, showing the bent knee of one leg supported by the knee support platform while the user takes a step with the good leg, from the first position to a second position;

FIG. 1C is an oblique angle view of the preferred embodiment of FIG. 1A, showing the bent knee of one leg supported by the knee support platform, the user having taken the step with the other leg, from the first position to the second position;

FIG. 1D is an oblique angle view of the preferred embodiment of FIG. 1A, showing the step completed, the user having removed the knee from the knee support platform and/or shifting his weight to the good leg, and moving the device to a third position about a distance of one step ahead of the second position;

FIG. 1E is an oblique angle view of the preferred embodiment of FIG. 1A, showing the device in place in the third position and the knee of the user about to be placed on the knee support platform;

FIG. 2A is an oblique angle view of the preferred embodiment of FIG. 1A, showing the user at the bottom of a stairway, the user having removed the knee from the knee support platform and standing erect on the good leg;

FIG. 2B is an oblique angle view of the preferred embodiment of FIG. 1A, illustrating the device in use as a adaptable mobility aid device on a stairway, and showing placement of the device on the bottom stair of the stairway;

FIG. 2C is an oblique angle view of the preferred embodiment of FIG. 1A, showing the bent knee of one leg supported by the knee support platform while the user takes a step with the good leg, from the bottom of the stair to the adjacent step;

FIG. 2D is an oblique angle view of the preferred embodiment of FIG. 1A, showing the bent knee of one leg supported by the knee support platform, the user having taken the step with the good leg, from the bottom of the stairway to the bottom stair step;

FIG. 2E is an oblique angle view of the preferred embodiment of FIG. 1A, showing the step completed, the user having removed the knee from the knee support platform and moving the device to the next stair step;

FIG. 3 is an oblique angle view of the preferred embodiment of FIG. 1A, showing use of the knee support platform as a seat for resting during climbing or descending stairs;

FIG. 3A is an oblique angle view of the preferred embodiment of FIG. 1A, showing the user at the top of the stairway, the user having removed the knee from the knee support platform and standing erect on the good leg;

FIG. 3B is an oblique angle view of the preferred embodiment of FIG. 1A, showing use of the knee support platform as a seat for resting during use of the device on a walkway, such as the level walkway;

FIG. 4 is an oblique angle view of the embodiment of FIG. 1A, showing the adaptable mobility aid device by itself to better portray the adjustment mechanism by which the length of the front legs can be adjusted;

FIG. 4A is an oblique bottom view of the preferred embodiment of FIG. 1A, showing in more detail the front adjustment mechanism;

FIG. 4B is an oblique angle view of an embodiment showing a portion of a pull bar spring-loaded via a spring-and-flange arrangement;

FIG. 5 is an oblique angle view of a preferred embodiment of the present invention, showing manual attachability and detachability of lower portions of the front legs of a adaptable mobility aid device to enable convertibility between use on a level walkway and use on a stairway;

FIG. 6 is an oblique angle view of a preferred embodiment of the present invention, showing an adjustable coupling configured to be single-hand operable, and showing the adaptable mobility aid device as having two front legs, and two rear legs;

FIG. 7 is an oblique angle view of a preferred embodiment of the present invention, showing an adaptable mobility aid device with a back support frame, and showing a portion of a front adjustment mechanism, and showing a rear adjustment mechanism;

FIG. 8 is an oblique angle view of a preferred embodiment of the present invention, showing an adaptable mobility aid device that includes a seat and a back support surface with the seat also adapted for use as a knee support platform;

FIG. 9 is an oblique angle view of a preferred embodiment of the present invention, showing the front legs, the rear legs, and the knee support platform in cooperation to enable collapsibility of the device;

FIG. 9A is an oblique angle view of a preferred embodiment of the present invention, showing an adaptable mobility aid device having a pair of front legs including a left front leg and a right front leg, a pair of rear legs including a left rear leg and a right rear leg, and a knee support platform in cooperation to enable collapsibility of the device;

FIG. 10 is an oblique angle view of a preferred embodiment of the present invention, showing an adaptable mobility aid device having a single adjustable front leg and a single adjustable rear leg;

FIG. 11 is an oblique angle view of a preferred embodiment of the present invention, showing an adaptable mobility aid device having front legs with front wheels, and rear legs with rear wheels, and a park bar;

FIG. 12A is an oblique angle view of a preferred embodiment showing an adaptable mobility aid device with front leg adjustability via an adjusting bar connected to the front legs;

FIG. 12B is an oblique angle view of a preferred embodiment, showing an adaptable mobility aid device having front leg adjustability via an adjusting bar mounted for sliding motion on support uprights;

FIG. 13 is an oblique angle view of a preferred embodiment showing front leg adjustability via a release handle coupled by a cable to spring loaded pins;

FIG. 13A is a front view showing the release handle of FIG. 13 in more detail;

FIG. 13B is a front view showing a pin actuator of FIG. 13 in more detail;

FIG. 13C is a front view showing a pin and spring arrangement of FIG. 13 in more detail;

FIG. 14 is an oblique angle view of a preferred embodiment similar to that shown in FIG. 5, but with the handle on the side of the device, rather than on the front;

FIG. 15 is an oblique angle view of a preferred embodiment, showing an adaptable mobility aid device with proportions altered for clarity, the adaptable mobility aid device including a plurality of interconnectable segments;

FIG. 16 is an exploded, oblique angle view of the preferred embodiment of FIG. 15 that shows the adaptable mobility aid device with proportions altered for clarity, the adaptable mobility aid device including the plurality of interconnectable segments;

FIG. 17 is a fragmentary view in elevation of an alternative spring arrangement belonging to the preferred embodiment of FIG. 15, this view showing a left pin and spring arrangement and a right pin and spring arrangement; and

FIG. 18 is a fragmentary view in elevation of the alternative spring arrangement belonging to the preferred embodiment of FIG. 15, this view showing an enlarged detail view of the right pin and spring arrangement.

### DETAILED DESCRIPTION

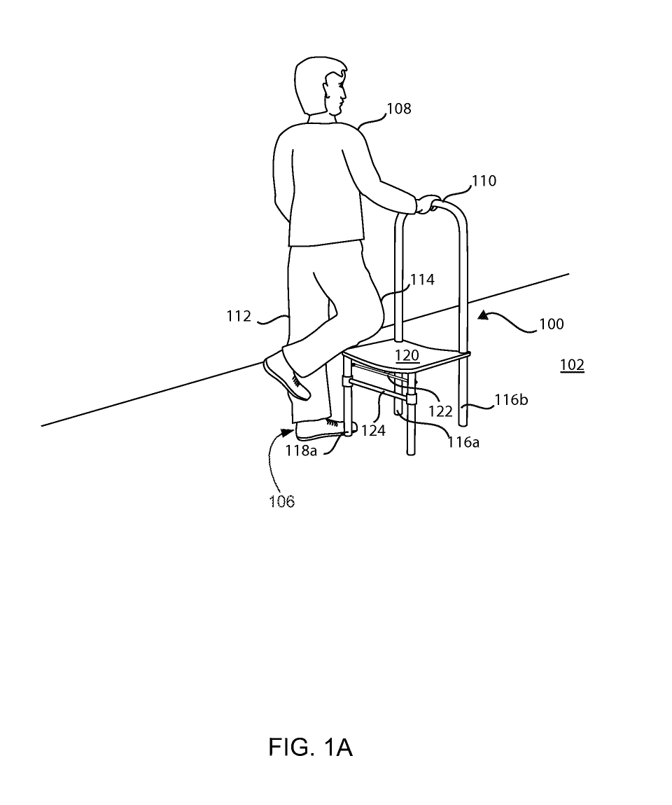

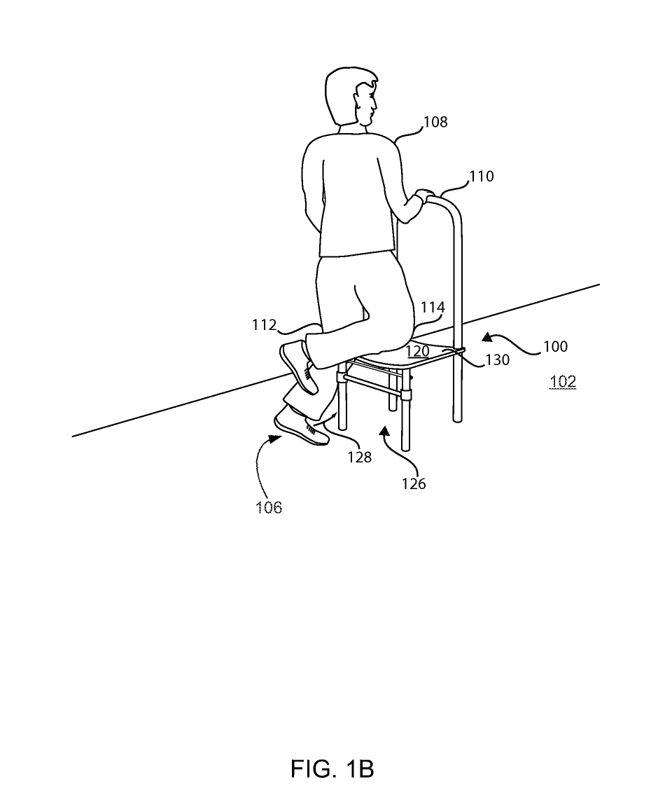

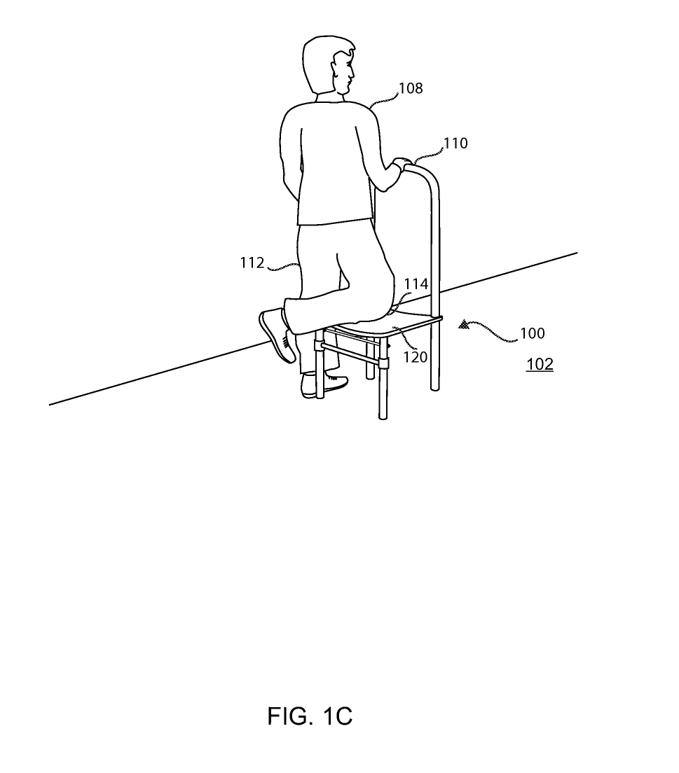

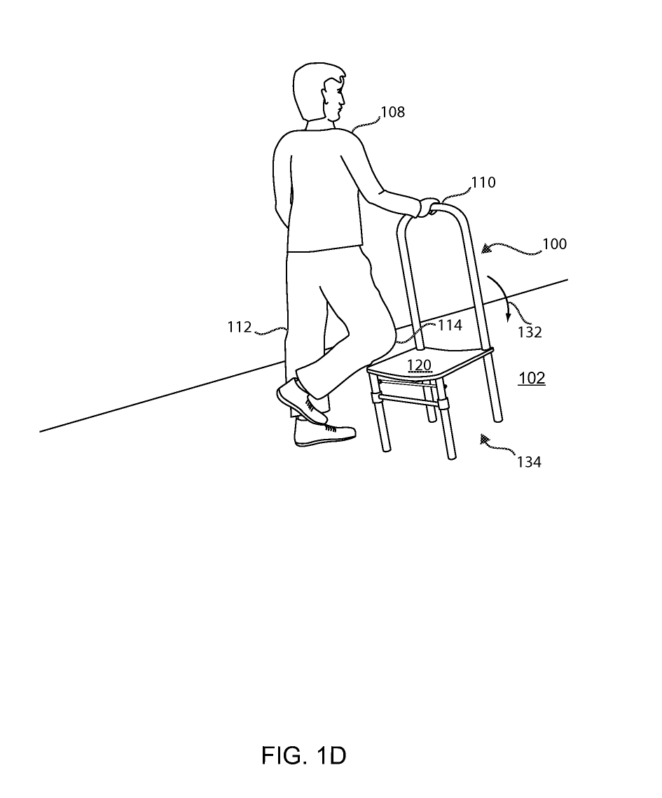

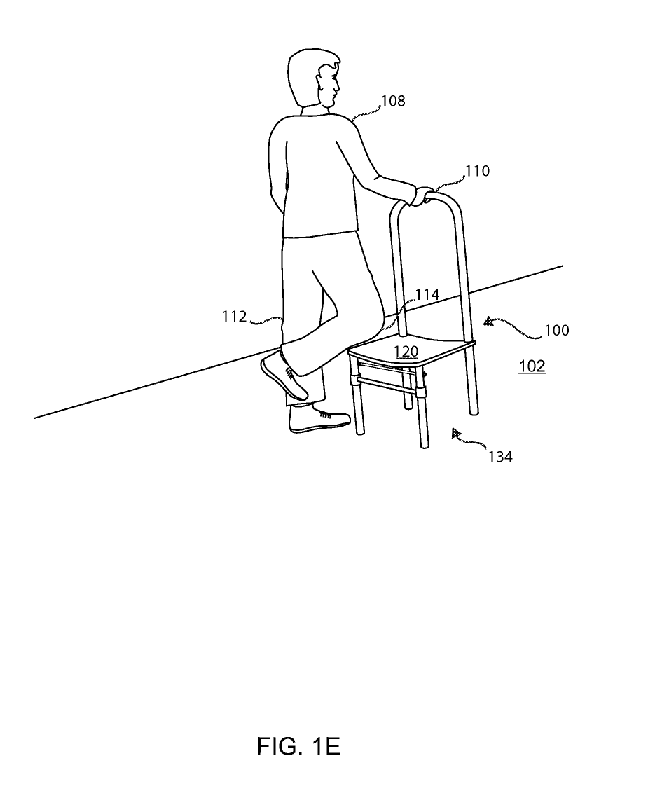

FIG. 1A through FIG. 1E depict a sequence of steps that illustrate the use of an adaptable mobility aid device in a preferred embodiment on a level walkway.

FIG. 1A is an oblique angle view of a preferred embodiment of the present invention in use as an adaptable mobility aid device 100 on a level walkway 102, showing the device in place in a first position 106 and a knee 114 of a user 108 about to be placed on a knee support platform 120. The user 108 of the device 100 is gripping the handle 110 of the device, and is standing erect on a leg 112 with the knee 114 of the other leg bent. The leg 112 is hereinafter referred to as the good leg. The adaptable mobility aid device 100 provides stable support at this point in the sequence so that the user 108 can use the device for knee support during movement of the good leg 112.

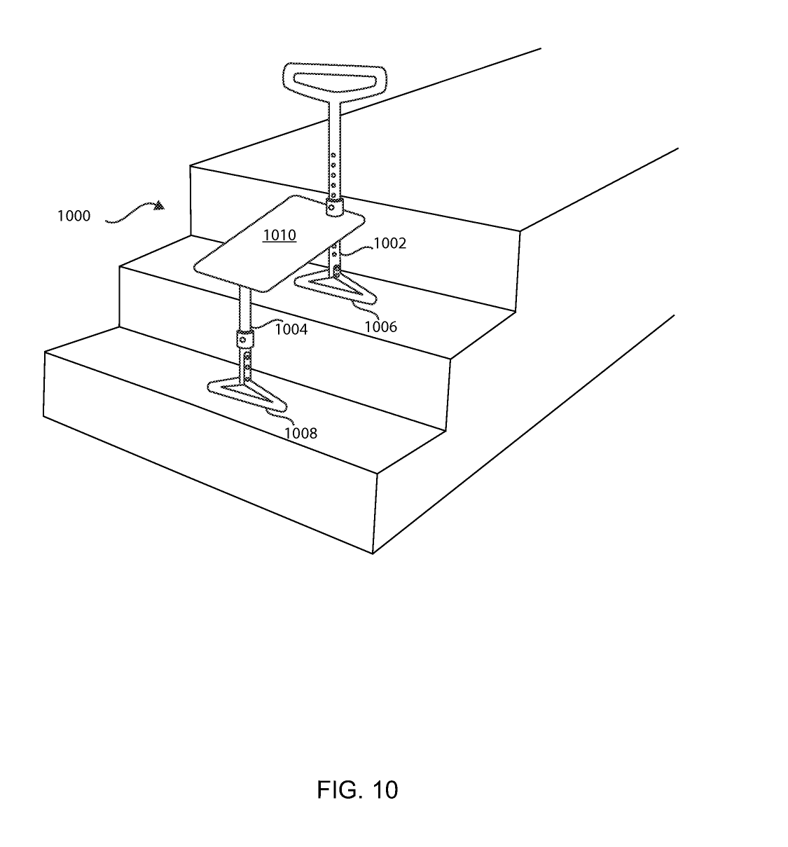

In the embodiment of FIG. 1A, the device 100 includes a pair of front legs 116a and 116b, a pair of rear legs 118a and 118b, as well as the knee support platform 120. As shown, the handle 110 is coupled to the knee support platform 120. In the embodiments described herein, the front legs 116a and 116b and the rear legs 118a and 118b are coupled to the knee support platform 120. In some preferred embodiments, the front legs 116a and 116b and the rear legs 118a and 118b are configured for frictional contact with a walkway and/or stairway. It is understood that embodiments of the present invention can have fewer than two front legs, for example, at least one front leg, and can have fewer than two rear legs, for example, at least one rear leg. FIG. 10, discussed below, shows an embodiment with one front leg and one rear leg. It is also understood that some embodiments can have three legs. In FIG. 1A, the device has a front side with which the at least one front leg is coupled, and the handle 110 forms a portion of the front side. Moreover, the at least one front leg and at least one rear leg are parallel, one with another.

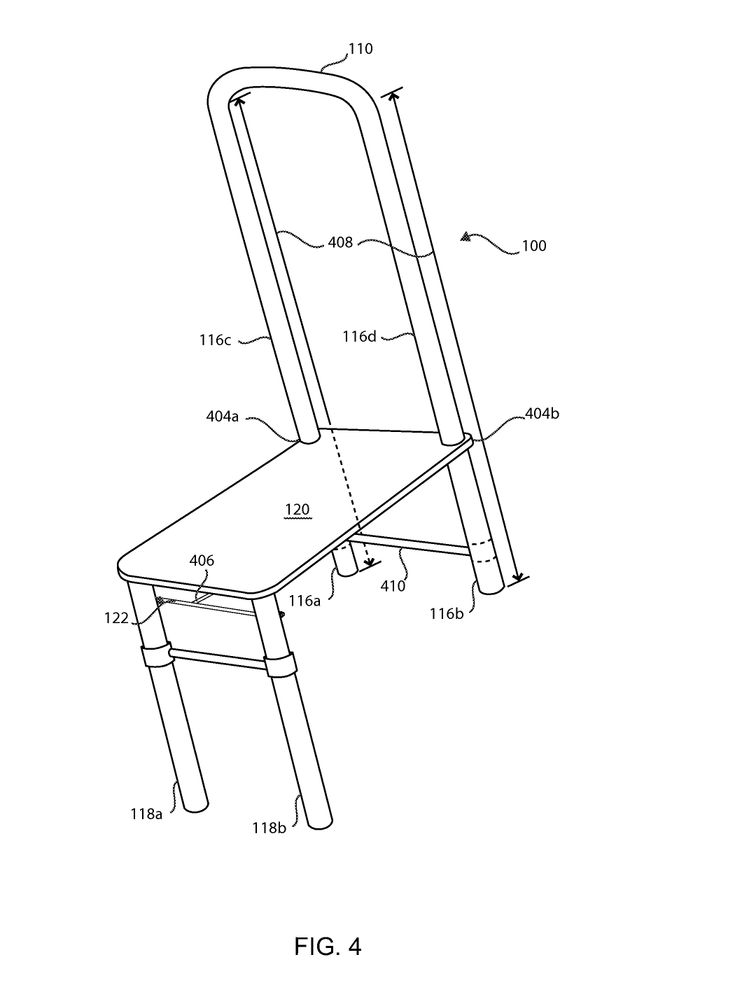

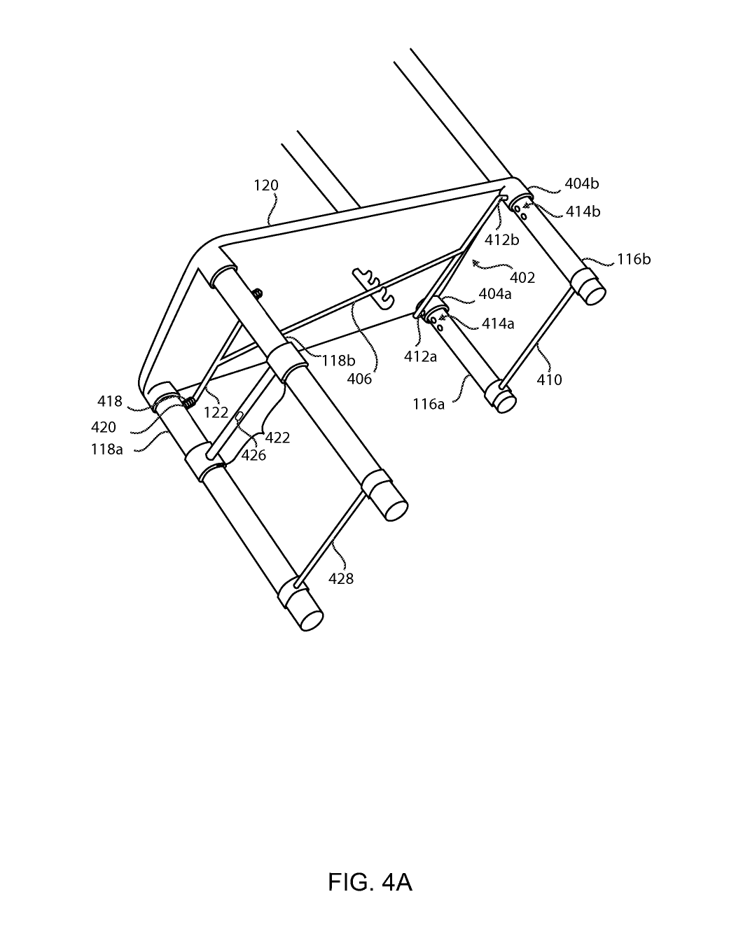

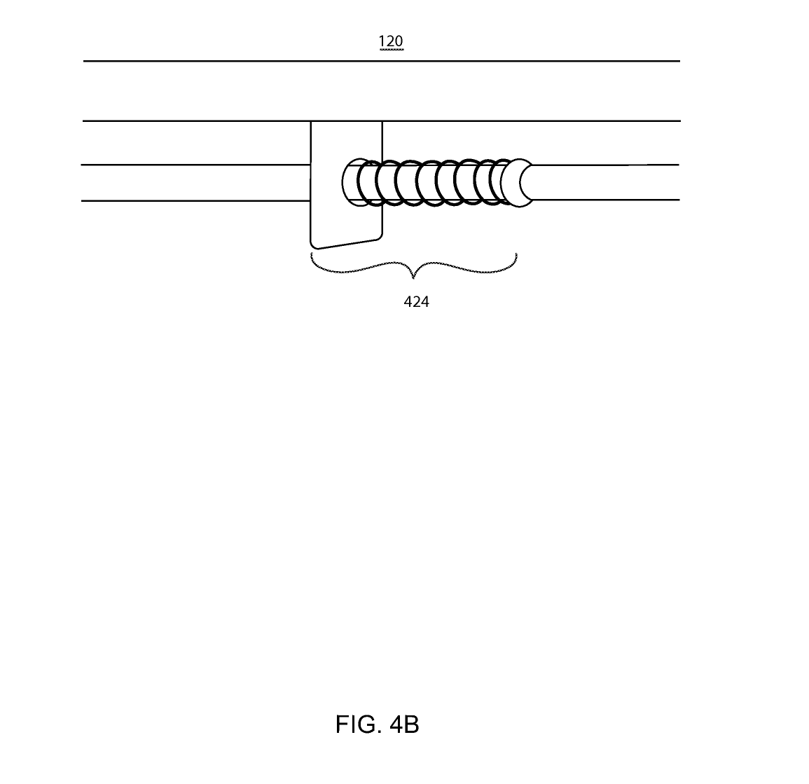

In FIG. 1A, an adjustment mechanism (402, see FIGS. 4 and 4A), also referred to herein as an adjustability mechanism, can be activated by a spring-loaded pull bar 122 to enable length adjustability of the front legs 116a and 116b. In various preferred embodiments discussed below, the adjustment mechanism includes an adjustable coupling, and is single hand operable through single hand operability of the adjustable coupling. A separate adjustment mechanism 124, likewise also referred to herein as an adjustability mechanism, enables length adjustability of the rear legs 118a and 118b. By use of the adjustment mechanisms 402 and 124, the device 100 can be adjusted so that the knee support platform 120 is at a comfortable height for use by the user 108.

FIG. 1B is an oblique angle view of the preferred embodiment of FIG. 1A, showing the bent knee 114 of one leg supported by the knee support platform 120 while the user 108 takes a step with the good leg 112, from the first position 106 (see FIG. 1A) to a second position 126. As shown in FIG. 1B, the user 108 continues to grip the handle 110 of the device 100, while the bent knee 114 bears the entire weight of the user.

Because the knee support platform 120 supports the knee 114, which supports the weight of the user 108 at this point in the sequence, the user can move the good leg 112 forward to take a step 128 without having to hop from the first position 106 to the second position 126. Moreover, the knee support platform 120 has a flat padded upper surface 130 to provide more comfortable support for the knee 114. In some preferred embodiments the upper surface 130 is contoured rather than flat.

FIG. 1C is an oblique angle view of the preferred embodiment of FIG. 1A, showing the bent knee 114 of one leg supported by the knee support platform 120, the user 108 having taken the step 128 (see FIG. 1B) with the other leg 112, from the first position 106 (see FIG. 1A) to the second position 126 (see FIG. 1B). The user 108 continues to grip the handle 110 of the device 100, while both the good leg 112 and the bent knee 114 can bear the weight of the user.

FIG. 1D is an oblique angle view of the preferred embodiment of FIG. 1A, showing the step 128 (see FIG. 1B) completed, the user 108 having removed the knee 114 from the knee support platform 120 and/or shifting his weight to the good leg 112, and moving 132 the device 100 to a third position 134 about a distance of one step ahead of the second position 126 (see FIG. 1B). The user 108 of the device 100 has lifted the device with one hand on the handle 110 of the device, and is standing erect on the good leg 112 with the knee 114 of the other leg bent.

FIG. 1E is an oblique angle view of the preferred embodiment of FIG. 1A, showing the device 100 in place in the third position 134 and the knee 114 of the user 108 about to be placed on the knee support platform 120. The user 108 having taken a step is thus brought to a similar point in the sequence as is shown above in FIG. 1A. In FIG. 1E, the user 108 of the device 100 is gripping the handle 110 of the device, and continues to stand on the good leg 112 with the knee 114 of the other leg bent. The adaptable mobility aid device 100 provides stable support at this point in the sequence so that the user 108 can use the device for knee support during movement of the good leg 112.

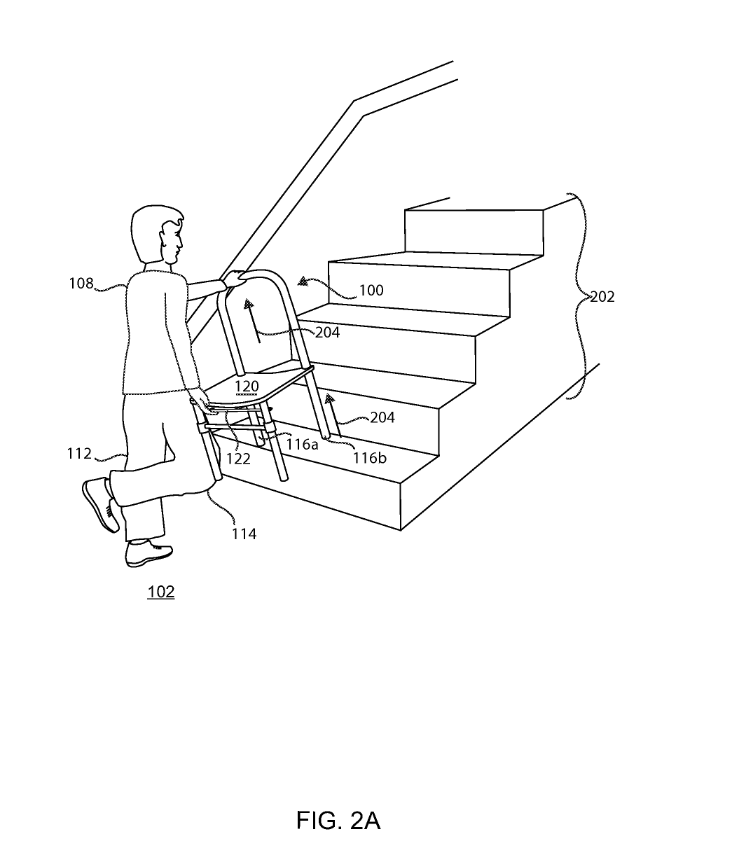

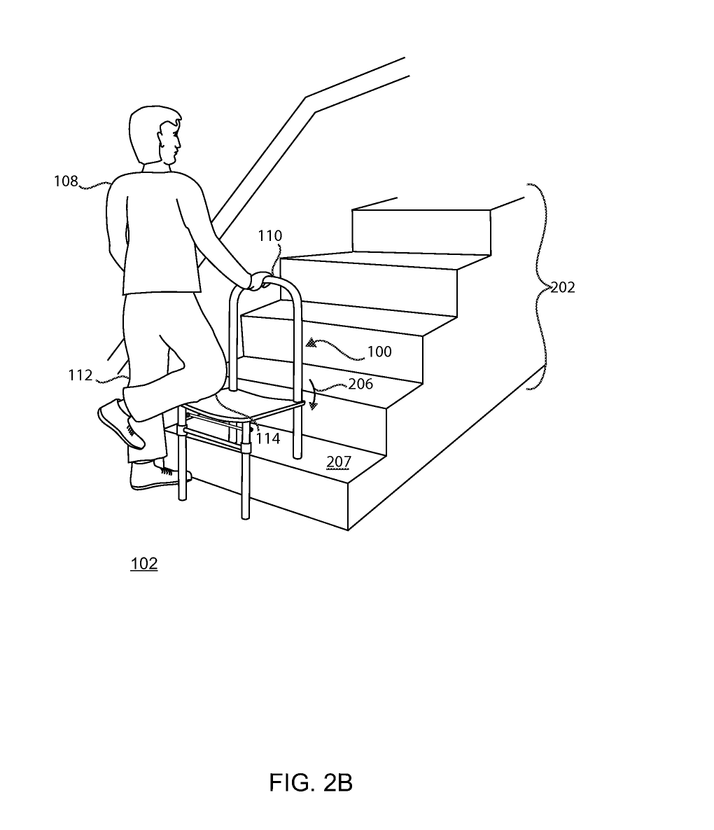

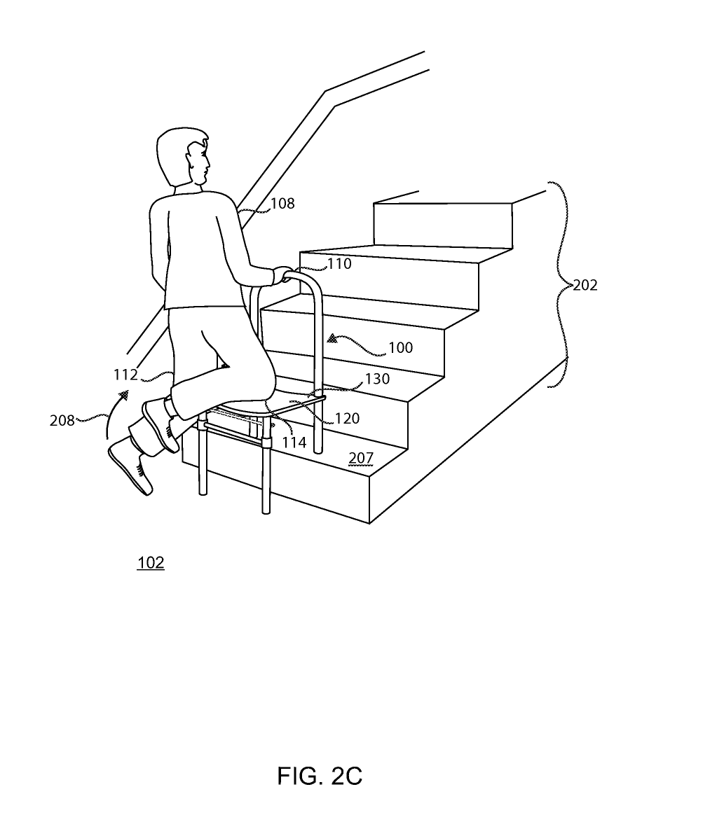

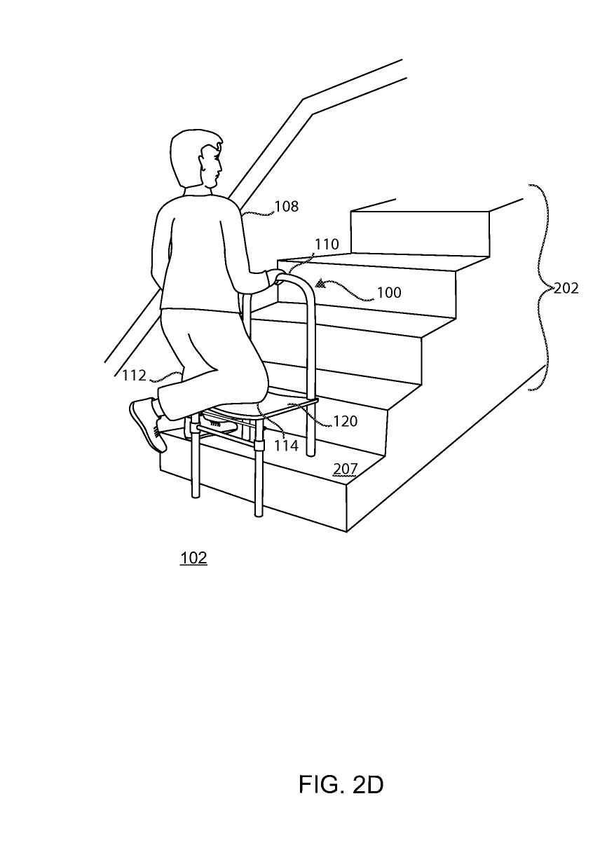

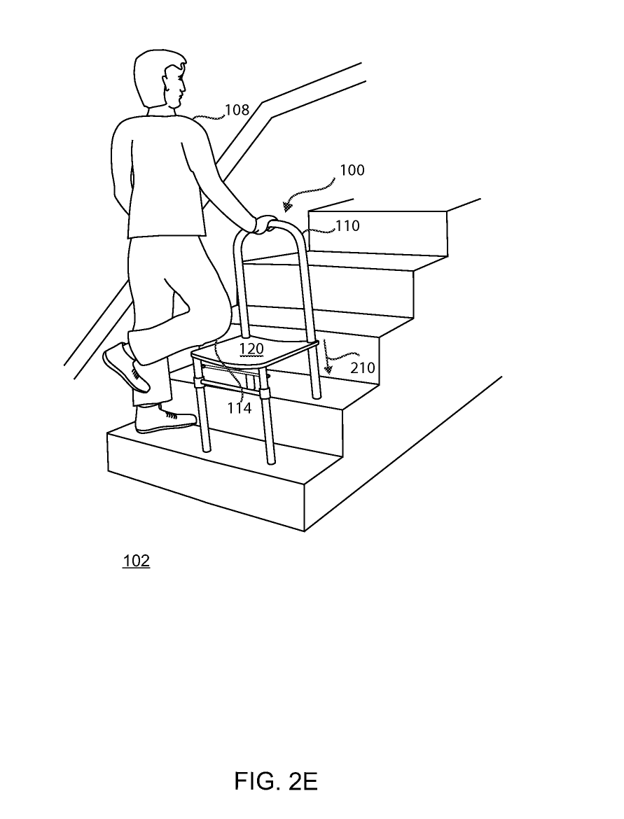

FIG. 2A through FIG. 2E depict a sequence of steps that illustrates the use of an adaptable mobility aid device in a preferred embodiment on a stairway.

FIG. 2A is an oblique angle view of the preferred embodiment of FIG. 1A, showing the user 108 at the bottom of a stairway 202, the user 108 having removed the knee 114 from the knee support platform 120 and standing erect on the good leg 112. The user 108 is operating an adjustment mechanism (402, see FIG. 4A) via the spring-loaded pull bar 122 to convert the device 100 from use on the level walkway 102 to use on the stairway 202 by shortening the front legs 116a, 116b as shown by the arrow 204. The adjustment mechanism 402 is single-hand operable via a pull by the user 108 and configured to shorten or lengthen the front legs 116a, 116b in tandem. By use of the adjustment mechanism 402, the device 100 can be adjusted so that the knee support platform 120 is level and remains at a comfortable height for use by the user 108, when the device is used on stairs.

FIG. 2B is an oblique angle view of the preferred embodiment of FIG. 1A, illustrating the device 100 in use as an adaptable mobility aid device on a stairway 202, and showing placement 206 of the device on the bottom stair 207 of the stairway. The user 108 of the device 100 has lifted the device with one hand on the handle 110 of the device, and is standing erect on the good leg 112 with the knee 114 of the other leg bent. For stairway use, the adaptable mobility aid device 100 is configured so that the front legs 116a and 116b (see FIG. 2A) engage an upper step and the rear legs 118a and 118b (see FIG. 1A) engage an adjacent lower step so as to support the knee support platform in a position over a portion of the upper step and over a portion of the adjacent lower step, and with the knee support platform disposed approximately horizontally. It will be appreciated that the device 100 is designed to straddle and span two steps for use on stairs, an aspect of the invention that will be discussed further below in connection with FIG. 2E. As used herein and in the accompanying claims, the term step refers to an upper surface of a stair step as well as a portion of a flat walkway adjacent a stairway.

FIG. 2C is an oblique angle view of the preferred embodiment of FIG. 1A, showing the bent knee 114 of one leg supported by the knee support platform 120 while the user 108 takes 208 a step with the good leg 112, from the bottom of the stair to the adjacent step 207. The user 108 continues to grip the handle 110 of the device 100, while the bent knee 114 bears the entire weight of the user.

Because the knee support platform 120 supports the knee 114, which supports the weight of the user 108 at this point in the sequence, the user can move the good leg 112 forward and upward to advance 208 to the stair step 207 without having to hop from the lower step to the next stair step. Moreover, as mentioned previously, the knee support platform 120 has a flat padded upper surface 130 to provide more comfortable support for the knee 114.

FIG. 2D is an oblique angle view of the preferred embodiment of FIG. 1A, showing the bent knee 114 of one leg supported by the knee support platform 120, the user 108 having taken the step with the good leg 112, from the bottom of the stairway 202 to the bottom stair step 207. The user 108 continues to grip the handle 110 of the device 100, while both the good leg 112 and the bent knee 114 can bear the weight of the user.

FIG. 2E is an oblique angle view of the preferred embodiment of FIG. 1A, showing the step completed, the user 108 having removed the knee 114 from the knee support platform 120 and moving 210 the device 100 to the next stair step. The user 108 of the device 100 has lifted the device with one hand on the handle 110 of the device, and is standing erect on the good leg 112 with the knee 114 of the other leg bent. It is understood that descending a step can be accomplished by a user by backing down the stairs and performing the steps shown in FIGS. 2A-2E in the reverse order.

As mentioned previously, the device 100 is designed to straddle and span two steps when used on a stairway. The capability of the device 100 to straddle two steps enhances the usability of the device on stairs, and can enhance the stability of a user employing the device, for several reasons. First, in various embodiments, the device 100 has a footprint of about 9 inches square or larger, contributing to its greater stability over currently available adaptable mobility aid devices with smaller footprints that generally rest on only a single step when used on stairs.

Second, during use on a stairway, an exemplary knee support platform is positioned so as to span two steps. Thus, while the user is taking a step, or when the user shifts his or her weight from the good leg, the weight of the user is distributed between the two steps. In this situation, a slight shift of the user's posture brings the majority of the user's weight to bear on the upper step, or on the lower step. This capability to shift the user's weight to the upper step or alternatively the lower step can make it easier for the user to mount or descend stairs.

Third, the positioning of the knee support platform over both steps results in the user's center of gravity being positioned about midway between the two steps. This is a much more natural positioning of the user's center of gravity while the user takes a step from one step to an adjacent step, whether ascending or descending. The more natural position can make it easier for the user to mount or descend stairs.

Fourth, use of the device 100 for descending stairs can better accommodate the frequently limited mobility of the user. The stairway descent is safer in that a user descends the stairs by lowering the good leg 112 first, then the device 100 is transported to the lower step with the weight of the user supported by the good leg. In contrast, when descending stairs using an adaptable mobility aid device that doesn't straddle two steps but instead rests on only a single step, typically a user is obliged to lower the device, and the injured leg, first. The knee of the good leg must be bent during this transition from one step to the lower step, while at the same time, the weight of the user must be borne by the good leg. Then, after the device and injured leg are positioned on the next lower step, a step to the lower step is taken with the good leg. The user may be put in an awkward and unstable position during part of this sequence. Furthermore, this mode of descent can be problematic for uncoordinated and/or elderly individuals.

Thus, by its design for straddling stairs, the device 100 fosters use of a more natural gait by the user during ascent and descent of stairs. Moreover, adjustment of the front legs of the device 100 to afford the stability just discussed can be done in seconds without tools, using a single hand to operate the adjustment mechanism.

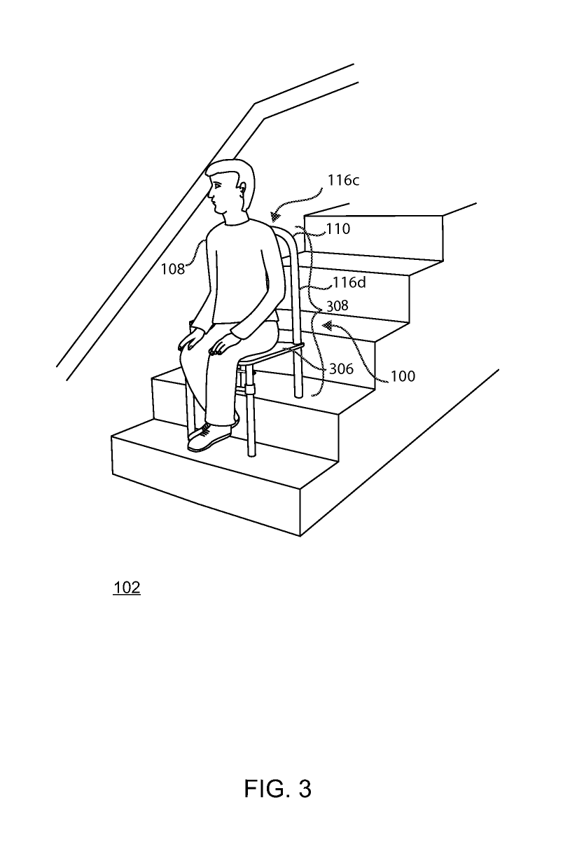

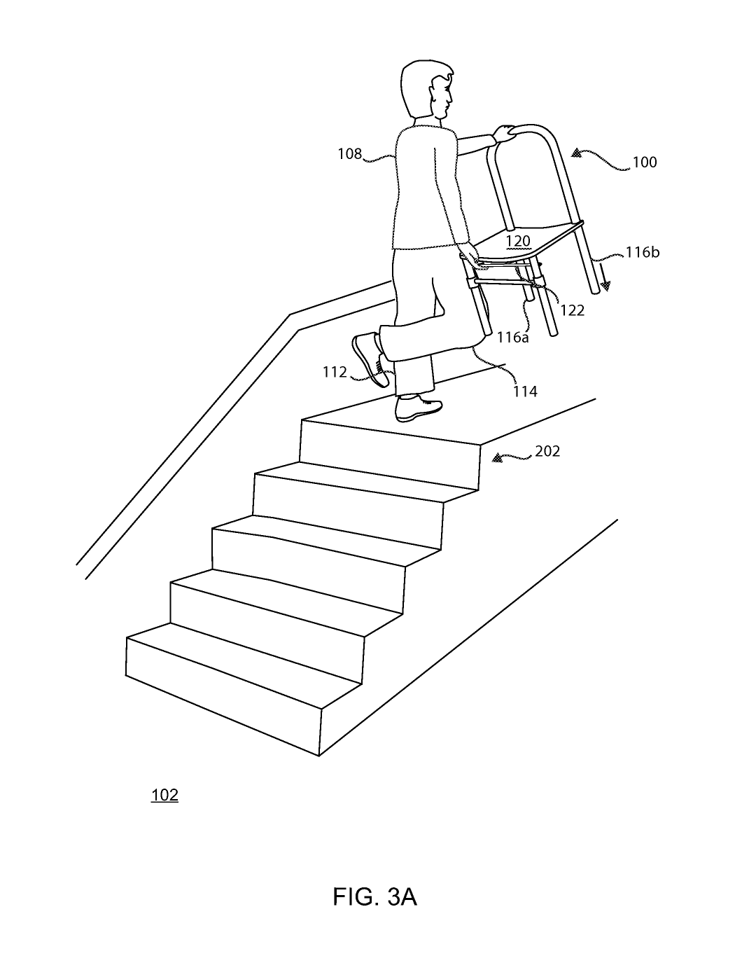

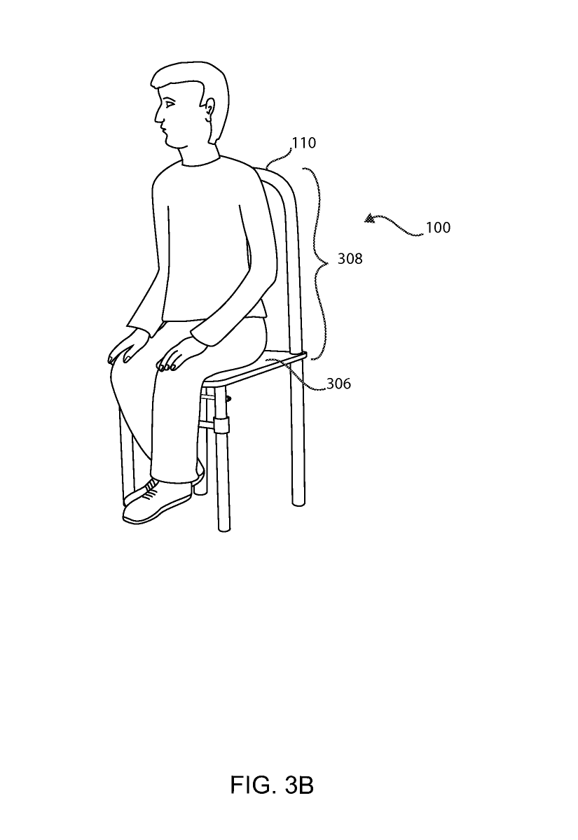

In many cases, an individual recovering from lower leg surgery or a leg injury can become fatigued by the effort of climbing or descending a staircase. Such individuals may wish to sit for a short time to gain a respite from the effort of climbing or descending. Embodiments of the present invention readily provide such respite from the exertion of stair use. Use of the device 100 as a seat for resting is discussed in connection with FIGS. 3 and 3B.

FIG. 3 is an oblique angle view of the preferred embodiment of FIG. 1A, showing use of the knee support platform 120 (see FIG. 1A) as a seat 306 for resting during climbing or descending stairs. The handle 110 of the device 100, along with the leg extensions 116c and 116d, which act as upright supports for the handle, form a back support frame 308 when the knee support platform 120 is in use as a seat 306. In this manner a user 108 of the adaptable mobility aid device 100 can recover to some extent from fatigue due to stair climbing or descending.

FIG. 3A is an oblique angle view of the preferred embodiment of FIG. 1A, showing the user 108 at the top of the stairway 202, the user having removed the knee 114 from the knee support platform 120 and standing erect on the good leg 112. The user 108 is operating the adjustment mechanism 402 (see FIG. 4A) to convert the device 100 from use on the stairway to use on a flat walkway by lengthening the front legs 116a and 116b. As mentioned previously, the adjustment mechanism 402 is single-hand operable, and is configured to lengthen the front legs 116a and 116b in tandem. As in FIG. 1E, the adjustment mechanism is operable via a pull of the pull bar 122 by the user 108, as shown. By use of the adjustment mechanism 402, the device 100 can be adjusted so that the knee support platform 120 is level and remains at a comfortable height for use by the user 108, when the device is used on a level walkway.

In many cases, an individual recovering from lower leg surgery or a leg injury can become fatigued even by the effort of walking on a level walkway. Such individuals may wish to sit for a short time to gain a respite from the effort of walking. Embodiments of the present invention readily enable respite from the exertion of walking on a level walkway, as discussed next.

FIG. 3B is an oblique angle view of the preferred embodiment of FIG. 1A, showing use of the knee support platform 120 (see FIG. 1A) as a seat 306 for resting during use of the device 100 on a walkway, such as the level walkway 102 (see FIG. 1A). The handle 110 of the device 100, along with the leg extensions 116c and 116d (see FIG. 3) that form upright supports for the handle, form a back support frame 308 when the knee support platform 120 is in use as a seat 306. It will be appreciated that adjustability of the front legs enables use of the device 100 as a seat even on an inclined walkway, should a user become fatigued during use of the device on the inclined walkway.

FIG. 4 is an oblique angle view of the embodiment of FIG. 1A, showing the adaptable mobility aid device 100 by itself to better portray the adjustment mechanism 402 by which the length of the front legs 116a and 116b can be adjusted. As shown in FIG. 4, the adjustment mechanism 402 includes two sleeves 404a and 404b coupled to the knee support platform 120. The legs 116a and 116b are coupled with the handle 110 through leg extensions 116c and 116d. In the preferred embodiment of FIG. 1A, the legs 116a and 116b, and the leg extensions 116c and 116d, have the same diameter, and are configured to nest within the sleeves 404a and 404b. Ordinarily, the legs and leg extensions 116a through 116d are locked in position until the adjustment mechanism 402 is activated. It is understood that leg adjustability can be enabled in other ways, for example, each leg may be configured as a rail sliding inside a groove or larger rail, and nesting need not mean only complete surrounding by the sleeve, but alternatively may encompass the interlocking of sliding rails as just described.

The adjustment mechanism 402 is activated when a pull on the pull bar 122 is communicated to the adjustment mechanism 402 by the linkage 406. The spring-loading of the pull bar 122 may be accomplished through the linkage 406 of the pull bar with, for example, spring-loaded pins (see FIG. 4A). When the adjustment mechanism is activated, the legs 116a and 116b can be lengthened or shortened together by a push down or pull up on the handle 110. That is, the leg 116a and the leg extension 116c have a fixed combined length 408. Similarly, the leg 116b and the leg extension 116d have the same fixed combined length 408. Thus, a push down on the handle 110 when the adjustment mechanism 402 is activated increases the length of the legs 116a and 116b below the knee support platform 120, while decreasing the lengths of the leg extensions 116c and 116d above the knee support platform. Conversely, a pull up on the handle 110 when the adjustment mechanism 402 is activated decreases the length of the legs 116a and 116b below the knee support platform 120, while increasing the lengths of the leg extensions 116c and 116d above the knee support platform.

It will be appreciated that other adjustment mechanisms having adjustable couplings can be adapted for use on an adaptable mobility aid device 100 by skilled artisans without undue experimentation. An adaptable mobility aid device that incorporates any such adjustment mechanism and/or adjustable coupling, and that embodies the inventive concepts described herein of straddling two adjacent steps during stairway use, is within the scope of the present disclosure. Preferred embodiments of the present invention that include alternative adjustment mechanisms and/or adjustable couplings are described in detail below.

In some alternative embodiments, the actuator for the adjustment mechanism may be positioned close to the front legs 116a and 116b, rather than close to the rear legs 118a and 118b as shown by the pull bar 122 and linkage 406. These details are discussed further in connection with FIG. 4A. Also, in some of these alternative embodiments, the legs 116a and 116b have a smaller diameter than the leg extensions 116c and 116d, and are configured to nest within the leg extensions, as well as nesting within the sleeves 404a and 404b. A crosspiece or crossbar 410 enables sliding of the legs 116a and 116b in tandem when the adjustment mechanism 402 is activated.

FIG. 4A is an oblique bottom view of the preferred embodiment of FIG. 1A, showing in more detail the front adjustment mechanism 402. The adjustment mechanism 402 includes a pair of sleeves 404a and 404b coupled to the knee support platform 120, each sleeve receiving a corresponding front leg 116a and 116b, respectively, for sliding motion unless the motion is restrained by a pin, for example, the pins 412a and 412b. Each of the pins 412a and 412b restrains sliding motion by interlocking with one of a series 414a or 414b of apertures in its corresponding leg 116a or 116b. The pins 412a and 412b are operated together for disengagement from their corresponding apertures by actuation of a spring-loaded bar 122. Moreover, various preferred embodiments can include a front crossbar or crosspiece 410 by which the front legs can be moved together in tandem. The bar 122 may be spring-loaded via one or more springs 418 positioned in, for example, slots or recesses 420 within the rear legs 118a and/or 118b.

FIG. 4B is an oblique angle view of an embodiment showing a portion of a pull bar spring-loaded via a spring-and-flange arrangement. In embodiment of FIG. 4B, the pull bar 122 or linkage 406 (see FIG. 4A) may be spring-loaded via one or more spring-and-flange arrangements 424 through which the sides of the pull bar traverse under the knee support platform 120, guiding the bar and keeping it tensioned. In some other embodiments, the pins 412a and 412b themselves can be spring-loaded, for example, by springs within the sleeves 404a and 404b, with the spring-loading of the pins providing corresponding spring-loading of the pull bar 122 via the linkage 406.

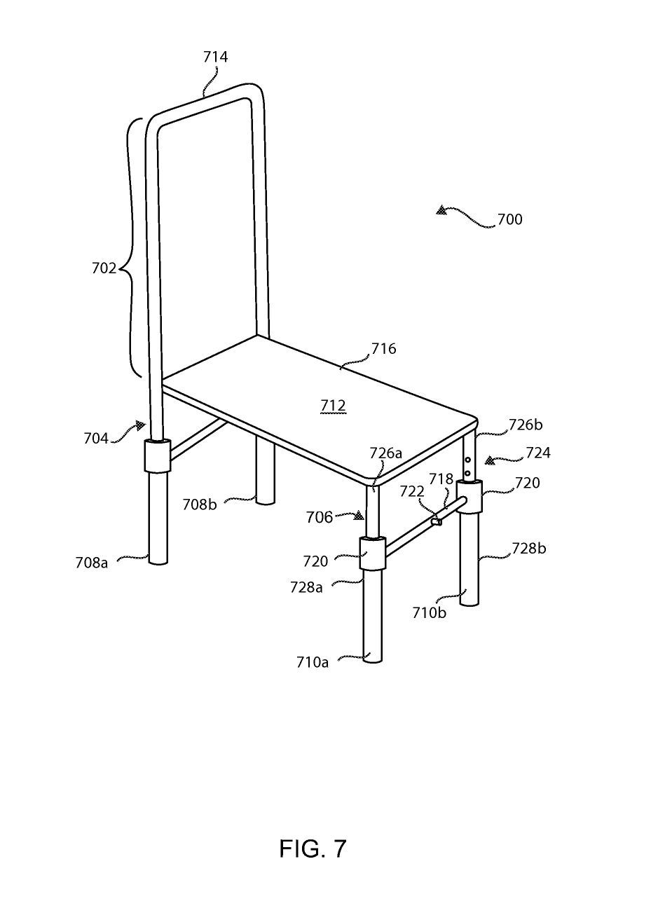

Resuming the discussion of FIG. 4A, it also shows a rear adjustment mechanism 422, that is single-hand operable, for example, via a push button 426. In preferred embodiments the rear legs 118a and 118b are connected by a rear crossbar 428 to enable tandem motion of the rear legs to adjust their length. Details of the rear adjustment mechanism are discussed below in connection with FIG. 7.

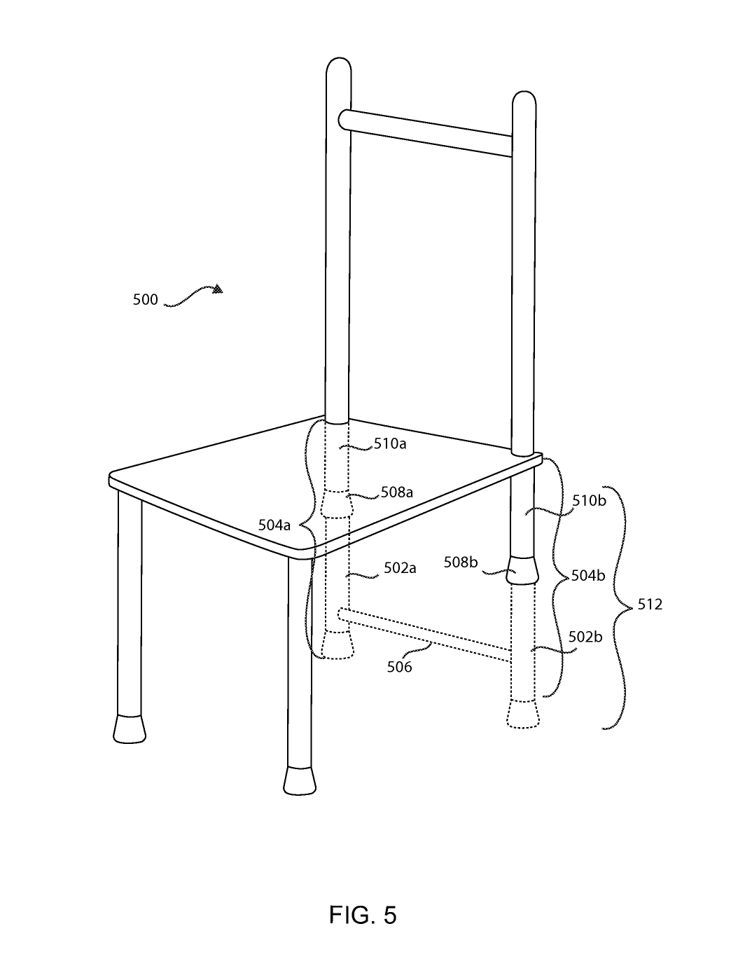

In some preferred embodiments of the present invention, the front legs may be attachable and detachable manually, for example, by using a cross bar to manipulate lower, detachable portions of the legs in tandem. FIG. 5 is an oblique angle view of a preferred embodiment of the present invention, showing attachability and detachability of lower portions 502a and 502b of the front legs 504a and 504b of an adaptable mobility aid device 500 to enable convertibility between use on a level walkway 102 (see FIG. 1A) and use on a stairway 202 (see FIG. 2A). In FIG. 5, the lower portions 502a and 502b of the front legs 504a and 504b are joined with a cross bar 506 to form an H-shaped structure, so that the lower portions of the front legs may be removed from corresponding sleeves 508a and 508b in the upper portions 510a and 510b of the front legs by pulling on the cross bar, thus shortening the front legs for use on stairs. Conversely, the legs can be lengthened by reversing the process to restore the lower portions 502a and 502b of the front legs 504a and 504b to nest in the sleeves 508a and 508b, so that the front legs 504a and 504b are of a length suitable for use on a level walkway. In this way the cross bar 506, sleeves 508a and 508b, and nesting lower portions 502a and 502b together comprise an adjustable coupling 512 that is single-hand operable to adjust the length of the front legs 504a and 504b.

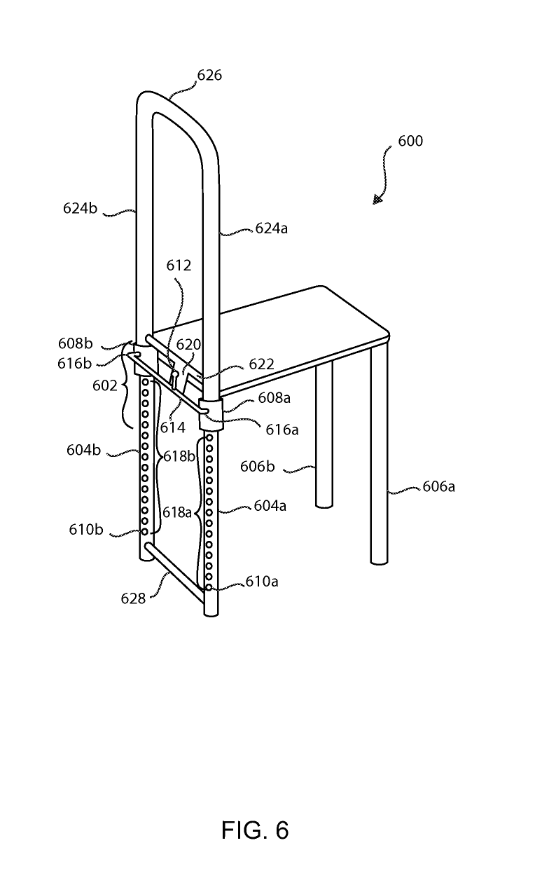

FIG. 6 is an oblique angle view of a preferred embodiment of the present invention, showing an adjustable coupling 602 configured to be single-hand operable, and showing the adaptable mobility aid device 600 as having two front legs 604a and 604b, and two rear legs 606a and 606b. Each of the front legs 604a and 604b includes a corresponding nesting portion 610a and 610b, and a corresponding sleeve portion 608a and 608b coupled to the nesting portion via the adjustable coupling 602. It is understood that the rear legs 606a and 606b may in addition have an adjustable coupling configured to be single-hand adjustable, so that the rear legs are length-adjustable as well (see, for example, FIG. 7).

As shown in FIG. 6, the adjustment mechanism includes a spring-loaded tab 612 on a connecting rod 614 that couples with two pins 616a and 616b. The spring loading is such that each pin 616a and 616b is normally urged into an aperture on the series 618a and 618b of apertures, if an aperture is available for engagement with the pin. The tab 612 can be pivoted on for example, a mounting protrusion or tongue 620 attached to a frame that supports the knee support platform 120 (see FIG. 1A), or to a horizontal support bar 622 fastened at each end to upright supports 624a and 624b. Pressing the tab 612 against the spring loading disengages the pins 616a and 616b from their respective apertures so that the front legs 604a and 604b can be shortened or lengthened as desired by sliding the front legs into or out of the upright supports 624a and 624b for the handle 626. Furthermore, in various embodiments a crossbar 628 connects the front legs 604a and 604b to enable sliding motion of the front legs in tandem.

In some other embodiments, the adjustment mechanism includes only a single sleeve and corresponding pin, that couple with a central shaft connected to the two front legs 604a and 604b. The central shaft includes a series of apertures that can mate with the pin to normally restrain motion of the central shaft. Activating the adjustment mechanism via a spring loaded tab enables motion of the central shaft within its sleeve, and thereby enables motion of the legs 604a and 604b within the upright supports 624a and 624b.

FIG. 7 is an oblique angle view of a preferred embodiment of the present invention, showing an adaptable mobility aid device 700 with a back support frame 702, and showing a portion of a front adjustment mechanism 704, and showing a rear adjustment mechanism 706. Each of the adjustment mechanisms 704 and 706 is configured for single-hand operability and configured to enable length adjustment of two legs alone or in tandem, that is front legs 708a and 708b alone or in tandem, and rear legs 710a and 710b alone or in tandem. The front legs 708a and 708b are capable of adjustment to a first length for use on stairs, and to a second length for use on a level walkway. In the preferred embodiment of FIG. 7, the device 700 also includes a knee support platform 712 coupled to the pair of front legs 708a and 708b, coupled to the pair of rear legs 710a and 710b, and coupled to the back support frame 702. In addition, the device 700 includes a handle 714 coupled to the back support frame 702. The knee support platform 712 has a flat upper surface 716, and is also adapted for use as a seat (306, see FIG. 3). As shown, the handle 714 is positioned so that it is on an opposite side of the knee support platform 712 when the device 700 is in use for walking or climbing (see, for example, FIGS. 1A-1E and FIGS. 2B-2E).

The rear adjustment mechanism 706 includes a cylindrical shell 718 that connects two sleeves 720. The shell 718 also contains spring loaded shafts (not shown) coupled to pins disposed within the sleeves 720. A push button 722 protrudes from the center of the shell 718, and is coupled to the spring loaded shafts so that a push of the push button results in withdrawal of each pin from one of a series of apertures 724 in the upper portions 726a and 726b of the legs. The upper portions 726a and 726b of the legs 710a and 710b are received within the sleeves 720 and nest within the lower portions 728a and 728b of the legs. In this manner the legs 710a and 710b can be adjusted to various lengths by a push of the push button 722 and motion of the cylindrical shell 718 to slide the lower portions 728a and 728b of the legs toward or away from the knee support platform 712. The construction and operation of the front adjustment mechanism 704 is similar.

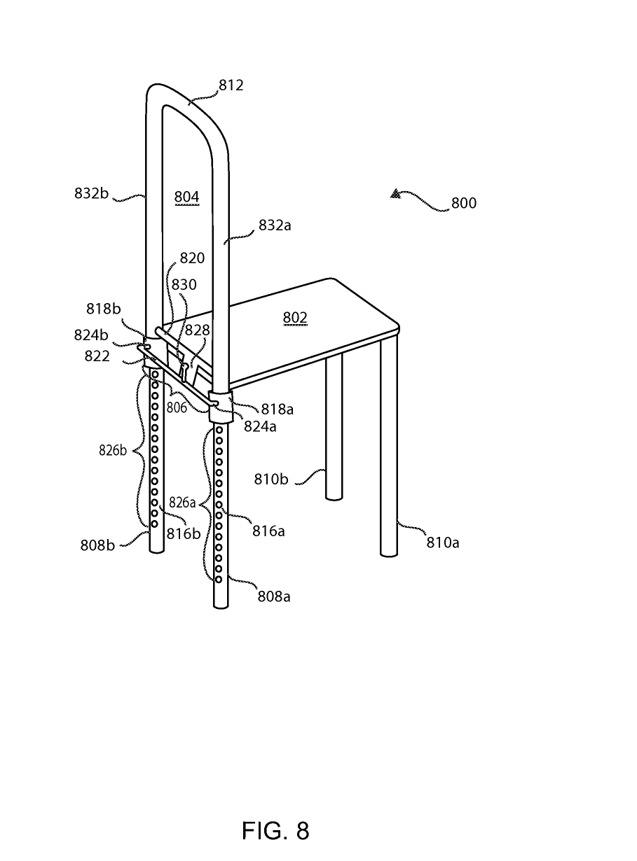

FIG. 8 is an oblique angle view of a preferred embodiment of the present invention, showing an adaptable mobility aid device 800 that includes a seat 802 and a back support surface 804. In addition to sitting, the seat 802 is adapted for use as a knee support platform 120 (see, for example, FIGS. 1A-1D). The embodiment of FIG. 8 also includes an adjustment mechanism 806 that can enable length adjustment in tandem of a pair of front legs 808a and 808b of the device 800, and that is single-hand operable. As with the other embodiments discussed in this disclosure, the front legs 808a and 808b are configured to engage a walking surface by frictional contact. In addition, the front legs 808a and 808b can be adjusted to a first length for use on stairs and to a second length for use on a level walkway.

The adaptable mobility aid device 800 also includes a pair of rear legs 810a and 810b which are configured to engage a walking surface by frictional contact. The rear legs 810a and 810b can be length-adjustable in tandem via single-hand operability (see, for example, FIG. 7). In addition, the device 800 includes a handle 812 that is coupled to the back support surface 804. As shown, the handle 812 is positioned so that it is on an opposite side of seat 802 when the device 800 is in use for walking or climbing where the seat is used as a knee support platform (see, for example, FIGS. 1A-1D and FIGS. 2B-2E). Also as shown in FIG. 8, the seat 802 is also coupled to the back support surface 804, as well as being coupled to the pair of front legs 808a and 808b, and to the pair of rear legs 810a and 810b. Moreover, in the preferred embodiment of FIG. 8, the handle 812 is coupled to the pair of front legs 808a and 808b, and is coupled to the back support surface 804 through the coupling of the handle to the pair of front legs.

In analogy with the embodiment shown in FIG. 6, the adjustability mechanism 806 is configured to enable length adjustment of the pair of front legs 808a and 808b, and configured for single-hand operability. Each of the front legs 808a and 808b includes a corresponding nesting portion 816a and 816b, and a corresponding sleeve portion 818a and 818b coupled to the nesting portion via the adjustable coupling 806. It is understood that the rear legs 810a and 810b may in addition have an adjustable coupling configured to be single-hand adjustable, so that the rear legs are length-adjustable as well (see, for example, FIG. 7).

As shown in FIG. 8, the adjustability mechanism 806 includes a spring-loaded tab 820 on a connecting rod 822 that couples with two pins 824a and 824b. The spring loading is such that each pin 824a and 824b is normally urged into an aperture of the series 826a and 826b of apertures, if an aperture is available for engagement with the pin. The tab 820 can be pivoted on for example, a mounting protrusion or tongue 828 attached to a frame that supports the knee support platform 802, or to a horizontal support bar 830 fastened at each end to upright supports 832a and 832b that couple the handle 812 to the front legs 808a and 808b. Pressing the tab 820 against the spring loading disengages the pins 824a and 824b from their respective apertures so that the front legs 808a and 808b can be shortened or lengthened as desired by sliding the front legs into or out of the upright supports 832a and 832b for the handle 812 and back support surface 804. Furthermore, in some embodiments a crossbar 628 (see FIG. 6) connects the front legs 808a and 808b to enable sliding motion of the front legs in tandem.

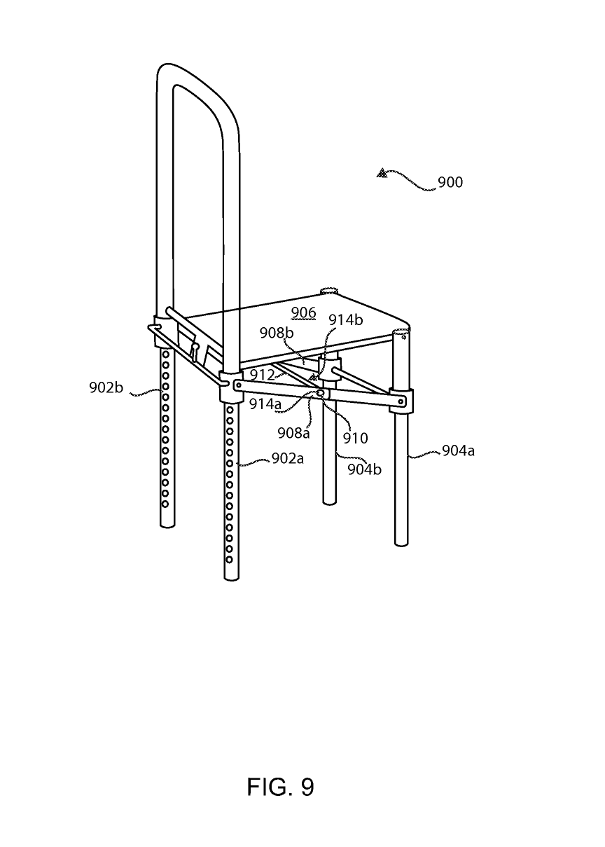

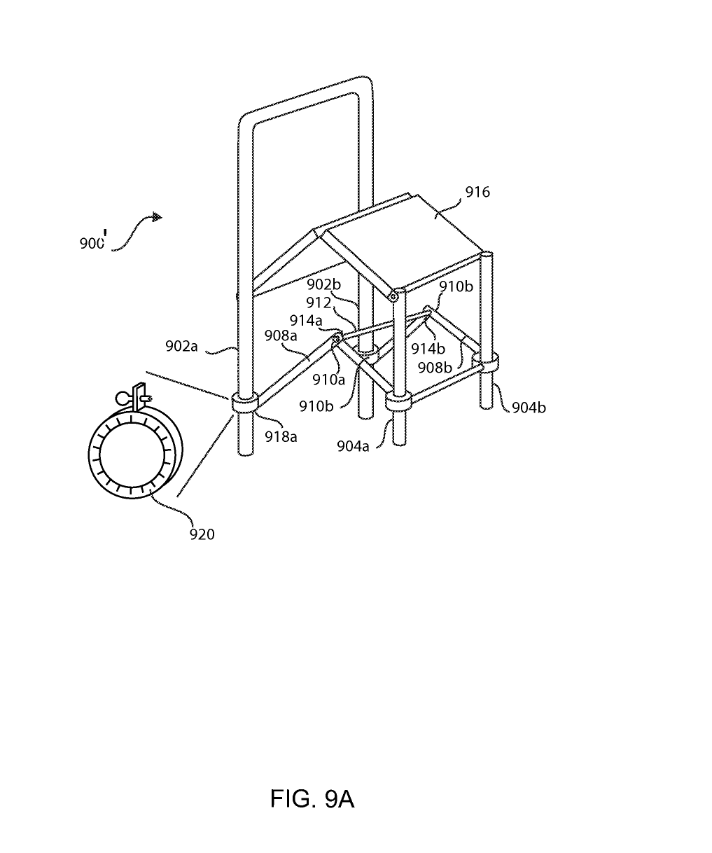

FIG. 9 is an oblique angle view of a preferred embodiment of the present invention, showing the walking aid device 900 having a pair of front legs including a left front leg 902a and a right front leg 902b, a pair of rear legs including a left rear leg 904a and a right rear leg 904b, and a knee support platform 906 in cooperation to enable collapsibility of the device. For clarity, details of the front and rear adjustment mechanisms have been omitted from FIG. 9. The knee support platform 906 can pivot with respect to the legs 902a, 902b, 904a, and 904b, and the device 900 is caused to collapse by bending of a left crossbrace 908a and a right crossbrace 908b that connect corresponding front and rear legs.

In the embodiment of FIG. 9, the left crossbrace 908a is pivotally attached to the left front leg 902a and pivotally attached to the left rear leg 904a. The left crossbrace 908a includes a pivot 910 within a central portion of the left crossbrace to enable bending of the left crossbrace. Similarly, the right crossbrace 908b is pivotally attached to the right front leg 902b and pivotally attached to the right rear leg 904b, the right crossbrace including a pivot (not shown) within a central portion of the right crossbrace to enable bending of the right crossbrace. A rod 912 having a left end 914a and a right end 914b is connected to the left crossbrace 908a at the left end 914a to form the pivot 910 of the left crossbrace, and connected to the right crossbrace 908b at the right end 914b to form the pivot of the right crossbrace. In this manner, a motion of the rod 912, for example, a pull downward on the rod, so as to cause bending of the left crossbrace 908a and the right crossbrace 908b, enables folding of the device 900 for storage, for example, in a closet or other storage area, or in an automobile or other vehicle. It will be appreciated that in some embodiments a folded adaptable mobility aid device 900 may also function as a cane.

FIG. 9A is an oblique angle view of a preferred embodiment of the present invention, similar in some respects to the embodiment of FIG. 9, showing a adaptable mobility aid device 900′ having a pair of front legs including a left front leg 902a and a right front leg 902b, a pair of rear legs including a left rear leg 904a and a right rear leg 904b, and a knee support platform 916 in cooperation to enable collapsibility of the device. For clarity, details of the front and rear adjustment mechanisms have been omitted from FIG. 9A. The knee support platform 916 can pivot with respect to the legs 902a, 902b, 904a, and 904b. The knee support platform 916 differs from knee support platform 906 of the embodiment of FIG. 9 in that the knee support platform 916 is foldable, as shown. The device 900′ is caused to collapse by bending of a left crossbrace 908a and a right crossbrace 908b that connect corresponding front and rear legs. By being foldable, the knee support platform 916 can work together with floating clamps 918a and 918b to enable collapsibility of the adaptable mobility aid device 900′.

In the embodiment of FIG. 9A (as with the embodiment of FIG. 9), the left crossbrace 908a is pivotally attached to the left front leg 902a and pivotally attached to the left rear leg 904a. The left crossbrace 908a includes a pivot 910a within a central portion of the left crossbrace to enable bending of the left crossbrace. Similarly, the right crossbrace 908b is pivotally attached to the right front leg 902b and pivotally attached to the right rear leg 904b, the right crossbrace including a pivot 910b within a central portion of the right crossbrace to enable bending of the right crossbrace. A rod 912 having a left end 914a and a right end 914b is connected to the left crossbrace 908a at the left end 914a to form the pivot 910a of the left crossbrace, and connected to the right crossbrace 908b at the right end 914b to form the pivot 910b of the right crossbrace.

As mentioned above, the knee support platform 916 is foldable. At the same time, the floating clamps 918a and 918b can slide along the corresponding front legs 902a and 902b, respectively, to accommodate the folding of the knee support platform 916. The floating clamps 918a and 918b may include, for example, a plastic insert 920 that reduces friction between the clamp and the leg, while providing a relatively tight fit between the clamp and the leg. In this manner, a motion of the rod 912, for example, a pull upward on the rod, so as to cause bending of the left crossbrace 908a and the right crossbrace 908b enables, folding of the device 900′ for storage, for example, in a closet or other storage area, or in an automobile or other vehicle. It will be appreciated that in some embodiments a folded adaptable mobility aid device 900′ may also function as a cane.

FIG. 10 is an oblique angle view of a preferred embodiment of the present invention, showing an adaptable mobility aid device 1000 having a single adjustable front leg 1002 and a single adjustable rear leg 1004. Each of the front leg 1002 and the rear leg 1004 include a broad support element 1006 and 1008, respectively, at its base to provide lateral stability to the device 1000. The front leg 1002 and the rear leg 1004 can be adjustable via any of the adjustability mechanisms previously described and suitably modified for use with a single leg rather than with legs in tandem. In this embodiment, the knee support platform 1010 is also tilted slightly upwards in the direction from the rear leg towards the front leg. This may be desirable for some users who do not wish to bend their knee at a full 90 degree angle, for example.

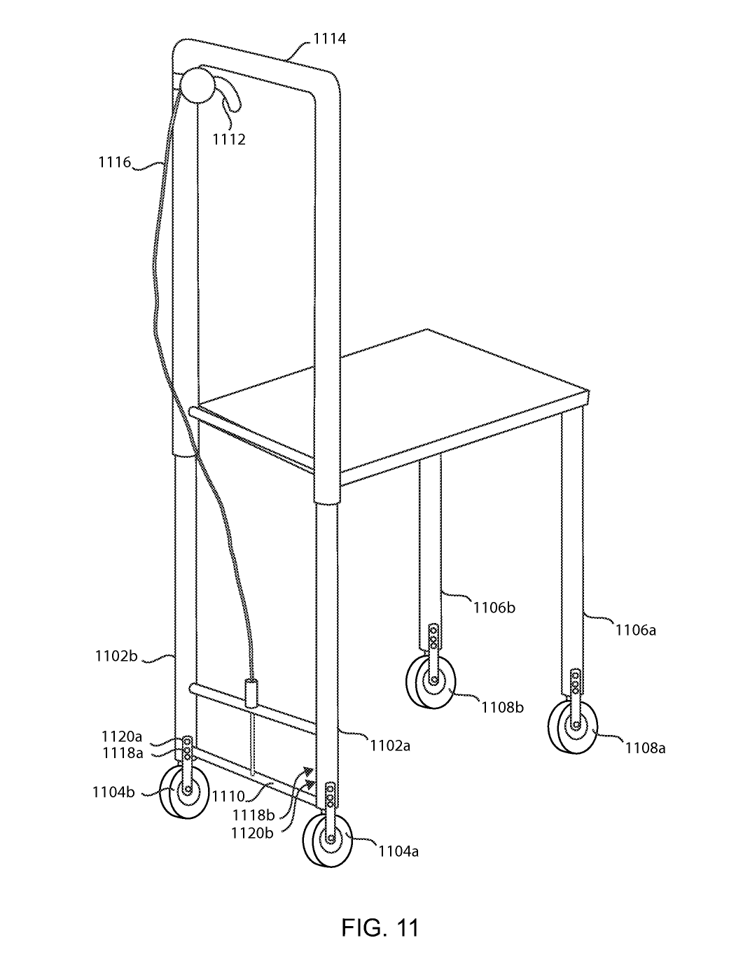

FIG. 11 is an oblique angle view of a preferred embodiment of the present invention, showing an adaptable mobility aid device 1100 having front legs 1102a and 1102b with front wheels 1104a and 1104b, and rear legs 1106a and 1106b with rear wheels 1108a and 1108b. A park bar 1110 can be operated by a lever 1112 near the handle 1114 to lock the front wheels 1104a and 1104b to prevent their movement when the device 1100 is used on stairs, or in other situations where rolling of the device is undesirable. The lever 1112 operates a cable 1116 to disengage the park bar 1110 from the front wheels 1104a and 1104b. The park bar 1110 is normally pressed into contact with the front wheels 1104a and 1104b by springs 1118a and 1118b disposed in slots 1120a and 1120b to resist motion of the front wheels. For clarity, details of the front and rear adjustment mechanisms are omitted from FIG. 11.

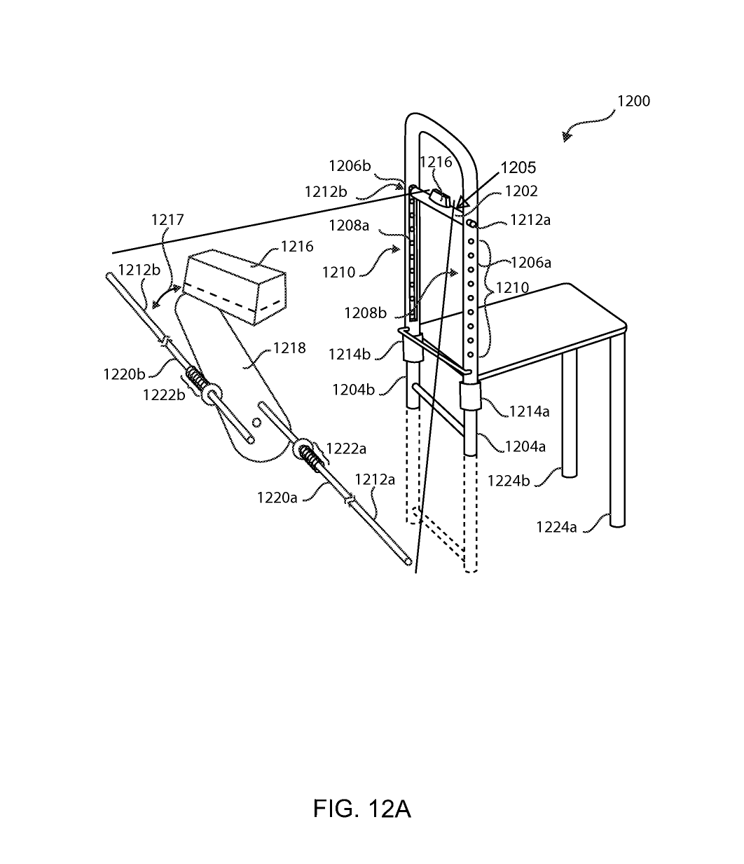

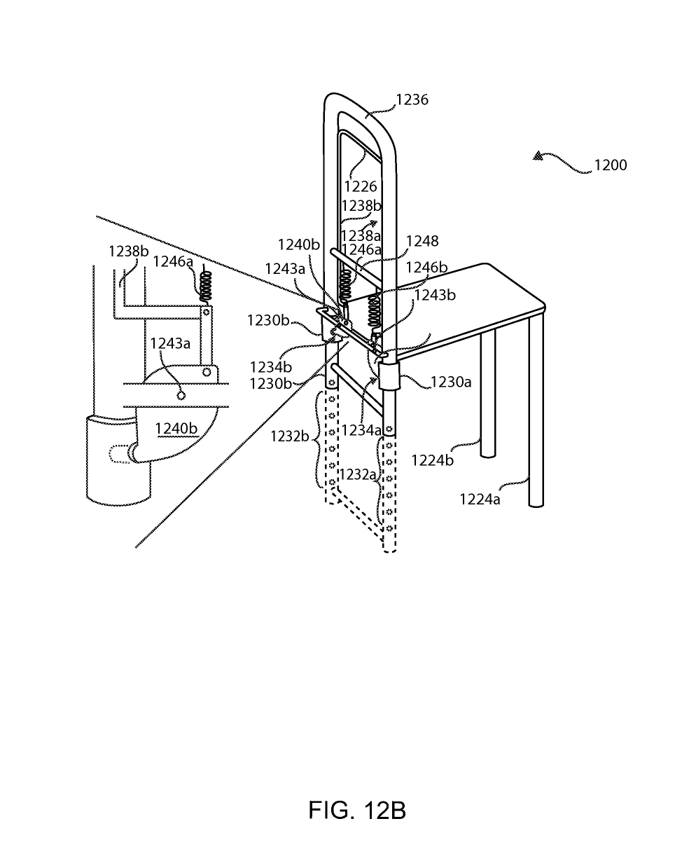

FIG. 12A is an oblique angle view of a preferred embodiment showing an adaptable mobility aid device 1200 with front leg adjustability via an adjusting bar 1202 connected to the front legs 1204a and 1204b, the adjusting bar acting as an adjustment mechanism 1205, as explained below. The front legs 1204a and 1204b are adapted to slide within support uprights 1206a and 1206b that include slots 1208a and 1208b to accommodate the adjusting bar 1202. The support uprights 1206a and 1206b also include apertures 1210 to receive pins 1212a and 1212b that can maintain the front legs 1204a and 1204b at a suitable length for stair use, or for use on a level walkway.

In more detail, the front legs 1204a and 1204b can slide via sleeves 1214a and 1214b within the support uprights 1206a and 1206b. Springs 1213a and 1213b, or other energy storage devices, for example, energy storage devices having pneumatic or hydraulic arrangements, provide a restoring force to the interior portions 1215a and 1215b of the front legs 1204a and 1204b, respectively, that slide within the support uprights 1206a and 1206b.

When the user on a level walkway arrives at a stairway, the user can place the device 1200 on the stairway so as to straddle both the end of the level walkway and the first step of the stairway. After the user activates the adjustment mechanism 1205, the weight of a user on the knee support platform 120 (see FIG. 1A) can force the front legs 1204a and 1204b to adjust to the appropriate leg length for stair use. When the user wishes to resume motion on a level walkway, the device 100 can be converted back to flat walkway use by lifting the knee 114 (see FIG. 1A) slightly from the knee support platform 120 and activating the adjustment mechanism 1205. The springs 1213a and 1213b then can exert force against the interior portions 1215a and 1215b to extend the front legs 1204a and 1204b. In this manner the device 1200 enables single hand adjustability of the length of the front legs 1204a and 1204b.

The adjustment mechanism 1205 includes a push button 1216 on the adjusting bar 1202 that can move 1217 a cam 1218 coupled to spring-loaded rods 1220a and 1220b that end with the pins 1212a and 1212b. Motion of the cam can draw the pins 1212a and 1212b from the apertures 1210 to enable the front legs 1204a and 1204b to slide for length adjustment. The spring loading of the pins 1212a and 1212b may be accomplished, for example, by spring and flange arrangements 1222a and 1222b. It is understood that the rear legs 1224a and 1224b may be length adjustable as described above in connection with other embodiments.

FIG. 12B is an oblique angle view of a preferred embodiment, similar in some respects to the embodiment of FIG. 12A, showing an adaptable mobility aid device 1200′ having front leg adjustability via an adjusting bar 1226 mounted for sliding motion on support uprights 1228a and 1228b. The front legs 1230a and 1230b are adapted to slide within the support uprights 1228a and 1228b, and include apertures, some of which are shown in dashed outline at 1232a and 1232b, that can mate with pins 1234a and 1234b operated via the adjusting bar 1226. The apertures 1232a and 1232b and pins 1234a and 1234b can maintain the front legs 1230a and 1230b at a suitable length for stair use, or for use on a level walkway. The adjusting bar 1226 is mounted near a handle 1236 for convenience of use.

As discussed above in connection with FIG. 12A, the front legs 1204a and 1204b can slide via sleeves 1214a and 1214b within the support uprights 1206a and 1206b. Springs 1213a and 1213b, or other energy storage devices, for example, energy storage devices having pneumatic or hydraulic arrangements, provide a restoring force to the interior portions 1215a and 1215b of the front legs 1204a and 1204b, respectively, that slide within the support uprights.

When the user on a level walkway arrives at a stairway, the user can place the device 1200 on the stairway so as to straddle both the end of the level walkway and the first step of the stairway. After the user activates the adjustment mechanism, the weight of a user on the knee support platform can force the front legs to adjust to the appropriate leg length for stair use. When the user wishes to resume motion on a level walkway, the device 100 can be converted back to flat walkway use by lifting the knee 114 slightly from the knee support platform and activating the adjustment mechanism. The springs 1213a and 1213b then can exert force against the interior portions 1215a and 1215b to extend the front legs 1204a and 1204b. In this manner the device 1200 enables single hand adjustability of the length of the front legs.

The adjusting bar 1226 is coupled to the pins 1234a and 1234b by rods 1238a and 1238b mounted on the support uprights 1228a and 1228b and capable of sliding motion along the support uprights. The rods 1238a and 1238b are pivotally connected to motion transfer plates 1240a and 1240b on which the pins 1234a and 1234b are mounted. The motion transfer plates 1240a and 1240b are mounted on a cross member 1242 at pivots 1243a and 1243b. An upward motion of the adjusting bar 1226 can thus result in rotation 1244 of the motion transfer plates 1240a and 1240b to withdraw the pins 1234a and 1234b from apertures in the front legs 1230a and 1230b currently mated with the pins, thus enabling the front legs to slide for length adjustability. Springs 1246a and 1246b coupled to an anchor member 1248 and to the motion transfer plates 1240a and 1240b provide a restoring force to allow the pins 1234a and 1234b to once again mate with available apertures on the front legs 1230a and 1230b. It is understood that the rear legs 1224a and 1224b may be length adjustable as described above in connection with other embodiments. It will also be appreciated that springs similar to 1213a and 1213b may be included in an adjustment mechanism for the rear legs 1224a and 1224b.

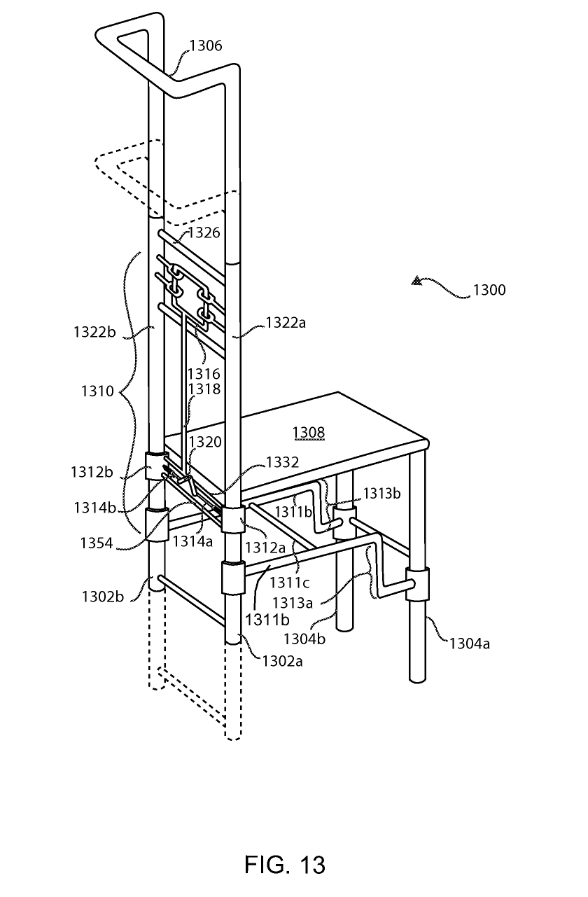

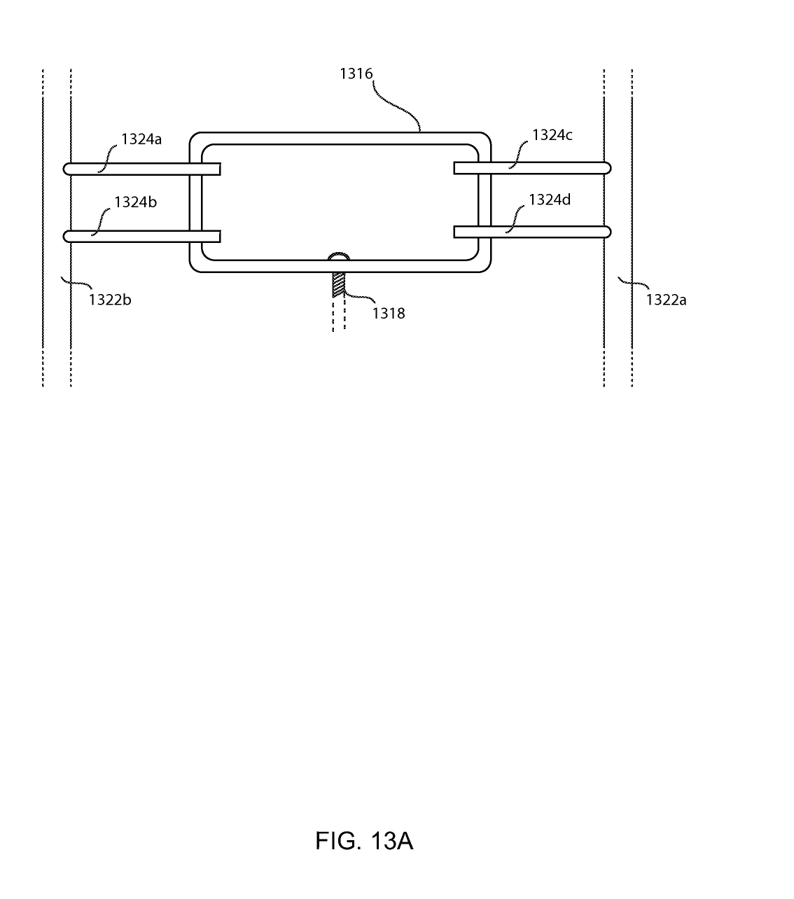

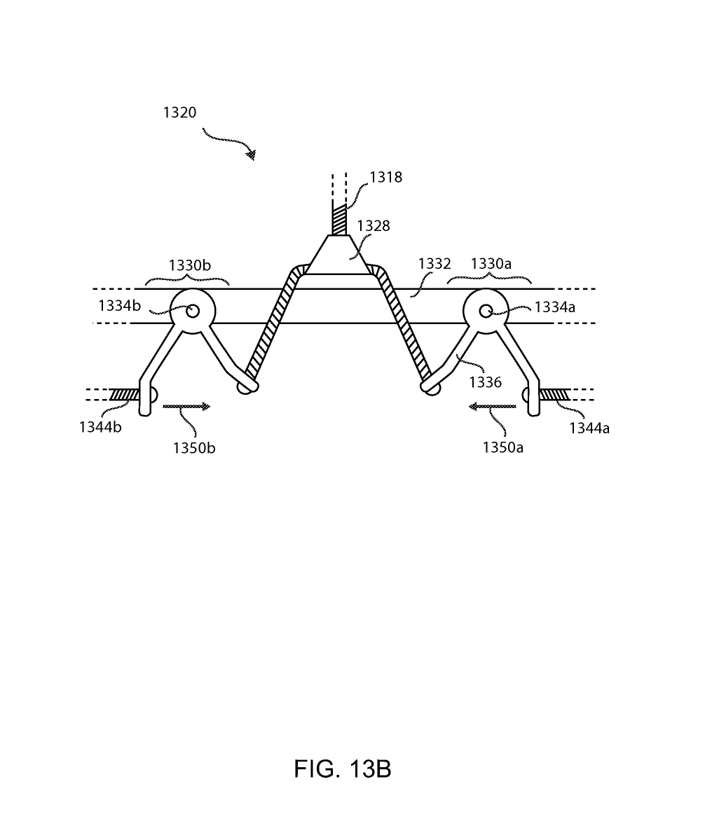

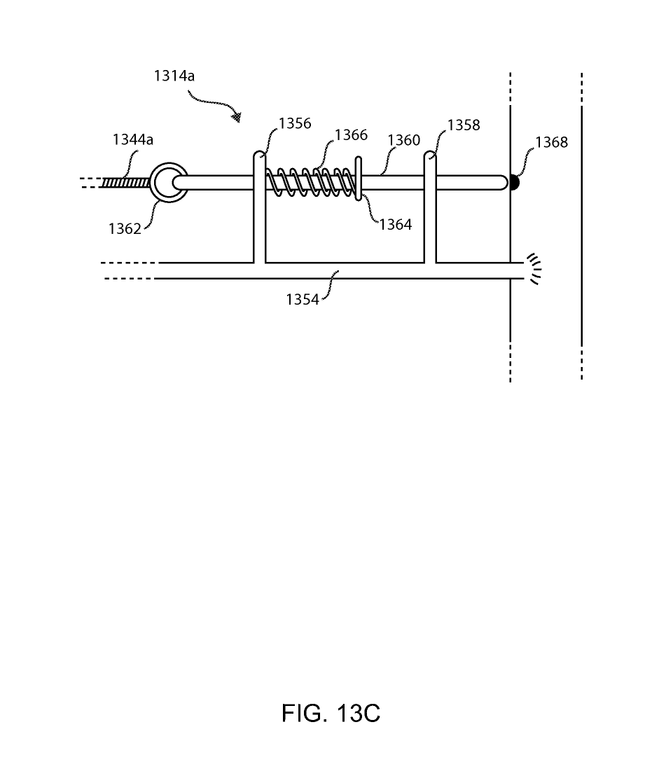

FIG. 13 is an oblique angle view of an embodiment of the present invention, showing an adaptable mobility aid device 1300 that affords single hand adjustability of the front legs 1302a and 1302b via a release handle coupled by a cable to spring loaded pins. The device 1300 also includes rear legs 1304a and 1304b, a handle 1306, a knee support platform 1308, and an adjustment mechanism 1310. The rear legs 1304a and 1304b can also be adjustable via a rear leg adjustment mechanism, for example, one similar to rear adjustment mechanism 422 (see FIG. 4A) or rear adjustment mechanism 706 (see FIG. 7). The rear legs 1304a and 1304b are connected with the front legs 1302a and 1302b via reinforcing members 1311a and 1311b connected by a cross member 1311c. The reinforcing members 1311a and 1311b are shown with doglegs or offsets 1313a and 1313b that enable greater adjustability of the rear legs.

The adjustment mechanism 1310 includes adjustable couplings in sleeves 1312a and 1312b, left and right pin and spring arrangements 1314a and 1314b, respectively, and a release handle 1316 connected by a cable 1318 to a pin actuator 1320. In various embodiments a rod may be used in place of the cable 1318.

The front legs 1302a and 1302b are configured to slide within support uprights 1322a and 1322b. The front legs 1302a and 1302b are coupled with the handle 1306 so that raising the handle raises the front legs, effectively shortening them. To lengthen the legs 1302a and 1302b, the handle 1306 can be pushed down. If the adjustment mechanism 1310 is not actuated, the front legs are held in position with respect to the adjustable couplings 1312a and 1312b by the left and right pin and spring arrangements 1314a and 1314b that engages apertures in the support uprights 1322a and 1322b and apertures (not shown) in the front legs 1302a and 1302b.

The adjustment mechanism 1310 is actuated via operation of the release handle 1316. FIG. 13A is a front view showing the release handle 1316 of FIG. 13 in more detail. As shown in FIG. 13A, the release handle 1316 is slidably coupled with the support uprights 1322a and 1322b by guides 1324a-1324d coupled to the support uprights. A crossbar, referred to herein as a lower handle 1326, is coupled to the support uprights 1322a and 1322b. A user 108 (see FIG. 1A) of the device 1300 can hold both the lower handle 1326 and the release handle 1316. By squeezing the release handle 1316 toward the lower handle 1326, the user 108 can draw the release handle upward, thereby drawing the end of the cable 1318 upward.

FIG. 13B is a front view showing the pin actuator 1320 of FIG. 13 in more detail. As shown in FIG. 13B, the other end of the cable 1318 is connected to the pin actuator 1320 at a saddle 1328. The pin actuator 1320 includes a first lever 1330a and a second lever 1330b pivotably mounted to a crosspiece 1332 via pivots 1334a and 1334b.

The first lever 1344 includes a first inside arm 1336 and a first outside arm 1338. The second lever 1330b includes a second inside arm 1340 and a second outside arm 1342. The first outside arm 1338 secures one end of a left cable 1344a connected to the left pin and spring arrangement 1314a. The second outside arm 1342 secures one end of a right cable 1344b connected to the right pin and spring arrangement 1314b. The denotations left and right typically refer to the perspective of a user using the device 1300.

One end of a transfer cable 1346 is connected to the first inside arm 1336. The other end of the transfer cable 1346 is connected to the second inside arm 1340. The saddle 1328 holds a middle portion of the transfer cable, and thus enables transfer of force from the cable 1318 to the transfer cable 1346. In alternative embodiments the first and second levers 1330a and 1330b can be replaced with two pulleys, with a longer transfer cable that engages the two pulleys and also replaces the cables 1344a and 1344b.

With this configuration, when the user 108 (see FIG. 1A) draws the release handle 1316 upward, the cable 1318, via the transfer cable 1346, draws the inside arms 1340 and 1336 upward, which results in the outside arms 1342 and 1338 drawing the ends of the cables 1344a and 1344b toward one another and way from the their nearest supports upright 1322a and 1322b, respectively, as shown by the arrows 1350a and 1350b. The motions of the cables 1344a and 1344b are communicated to the pins of the pin and spring arrangements 1314a and 1314b, discussed next.

FIG. 13C is a front view showing the pin and spring arrangement 1314a of FIG. 13 in more detail. As shown in FIG. 13C, the left pin and spring arrangement 1314a includes a holding bracket 1354 that spans the two support uprights 1322a and 1322b. The holding bracket includes two vertical members 1356 and 1358 for the left pin and spring arrangement 1314a, through which a pin 1360 passes. A ring 1362 at one end of the pin 1360 connects the pin with the other end of the cable 1344a. A spring 1366 encircles the pin 1360, and is positioned between the vertical member 1356 and a washer 1364 fixed to the pin. When the cable 1344a is drawn away from the support upright 1322a a sufficient distance, the pin 1360 is drawn out of an aperture 1368, and the washer 1364 compresses the spring 1366 against the vertical member 1356. Thus, when the pin actuator 1320 is no longer activated, that is, when the user 108 (see FIG. 1A) releases the release handle 1316, the energy stored in the compressed spring 1366 can be released, with the pin 1360 moving back into the aperture 1368. When the pin 1360 moves back into the aperture 1368, the pin can engage one of a series of apertures similar to the series 618a (see FIG. 6) but disposed on the leg 1302a so as to align with the aperture 1368, and the pin can thereby secure the left leg against sliding within the support upright 1322a. The right pin and spring arrangement 1314b is configured similarly.

In other embodiments, interior springs 1213a and 1213b (see FIG. 12A), or other energy storage devices, for example, energy storage devices having pneumatic or hydraulic arrangements, provide a restoring force to interior portions 1215a and 1215b of the front legs 1302a and 1302b, respectively, that slide within the support uprights 1322a and 1322b.

Thus, in these other embodiments, when the user 108 (see FIG. 1A) on a level walkway arrives at a stairway, the user can place the device 1300 on the stairway so as to straddle both the end of the level walkway and the first step of the stairway. After the user activates the adjustment mechanism 1310, the weight of a user on the knee support platform 1308 can force the front legs 1302a and 1302b to adjust to the appropriate leg length for stair use. When the user 108 wishes to resume motion on a level walkway, the device 1300 can be converted back to flat walkway use by lifting the knee 114 slightly from the knee support platform 1308 and activating the adjustment mechanism 1310. The springs 1213a and 1213b (see FIG. 12A) then can exert force against the interior portions 1215a and 1215b of the front legs 1302a and 1302b to extend the front legs. In this manner the device 1300 enables single hand adjustability of the length of the front legs 1302a and 1302b.

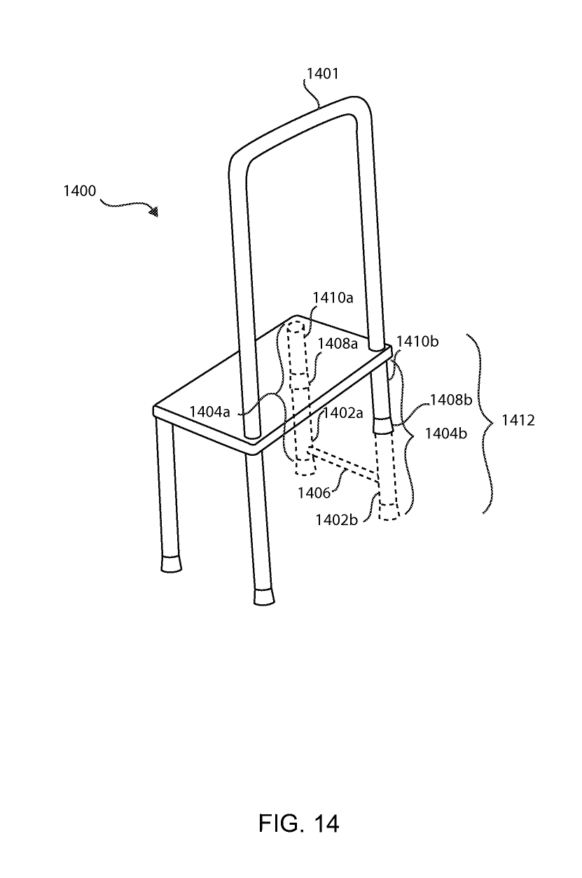

FIG. 14 is an oblique angle view of a preferred embodiment similar to that shown in FIG. 5, but with the handle 1401 on the side of the device 1400, rather than on the front. As with the embodiment of FIG. 5, the front legs 1404a and 1404b may be attachable and detachable manually, for example, by using a cross bar to manipulate lower, detachable portions of the legs in tandem. In FIG. 14, the lower portions 1402a and 1402b of the front legs 1404a and 1404b are joined with a cross bar 1406 to form an H-shaped structure, so that the lower portions of the front legs may be removed from corresponding sleeves 1408a and 1408b in the upper portions 1410a and 1410b of the front legs by pulling on the cross bar, thus shortening the front legs for use on stairs. Conversely, the legs can be lengthened by reversing the process to restore the lower portions 1402a and 1402b of the front legs 1304a and 1404b to nest in the sleeves 1408a and 1408b, so that the front legs 1404a and 1404b are of a length suitable for use on a level walkway. In this way the cross bar 1406, sleeves 1408a and 1408b, and nesting lower portions 1402a and 1402b together comprise an adjustable coupling 1412 that is single-hand operable to adjust the length of the front legs 1404a and 1404b.

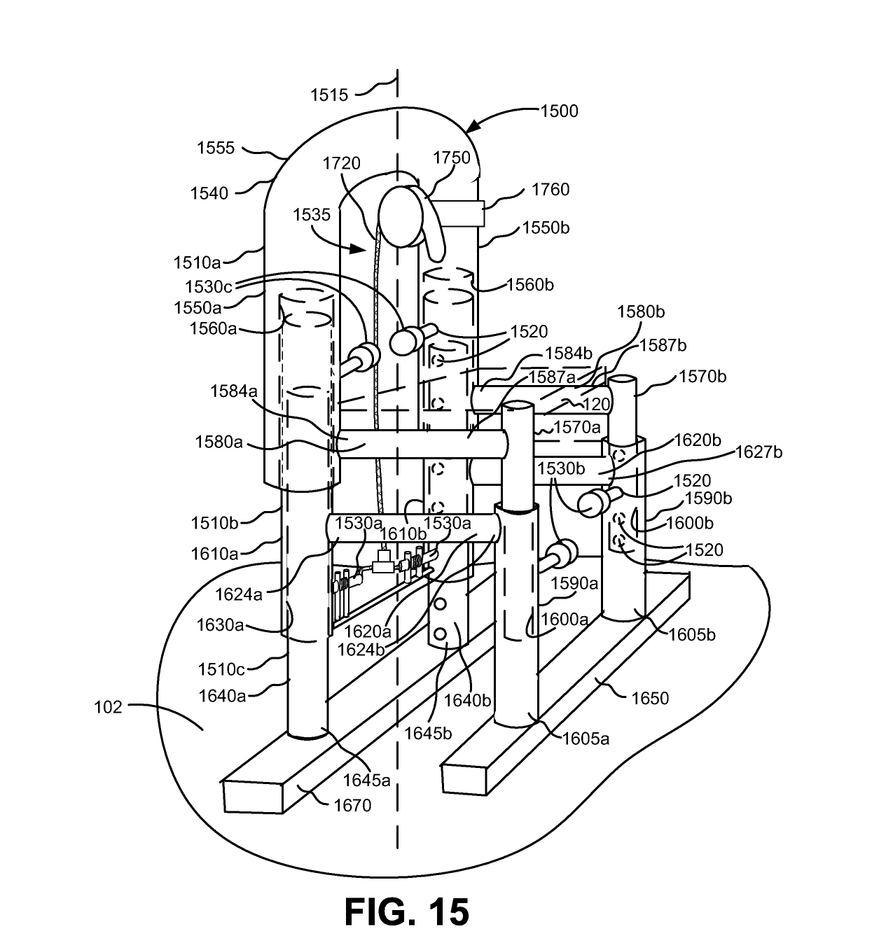

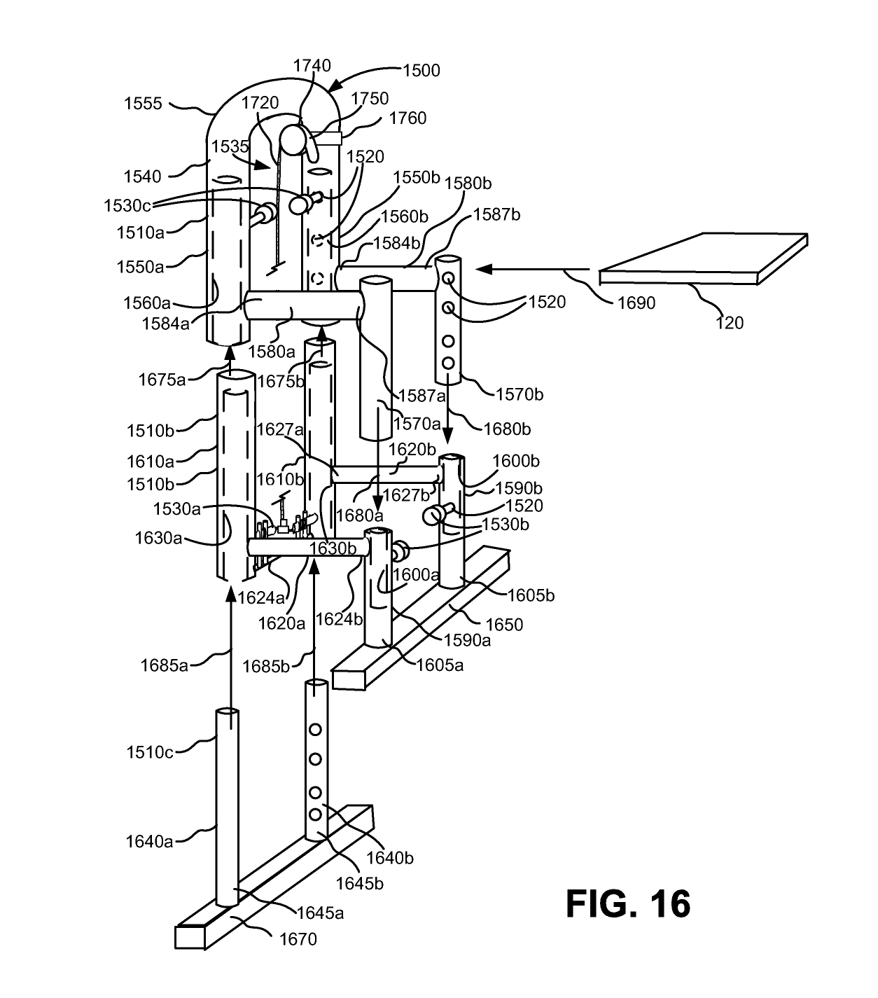

Referring to FIGS. 15 and 16, there is shown a preferred embodiment of a segmented adaptable mobility aid device, generally referred to as 1500, particularly for use on stairway 202 (see FIG. 2A). Segmented adaptable mobility aid device 1500 may also be used on level or inclined walkway 102 (see FIG. 2A), if desired. As shown in FIGS. 15 and 16, segmented adaptable mobility aid device 1500 includes a plurality of vertically aligned, interconnectable segments comprising a first segment 1510a, a second segment 1510b and a third segment 1510c. Segments 1510a/1510b/1510c are stackable end-to-end and alignable generally along a vertical axis 1515 for reasons described hereinbelow. Although three interconnectable segments 1510a, 1510b and 1510c are shown, it should be appreciated that the invention is not limited to three interconnectable segments. More than three interconnectable segments may be provided, if desired, and configured according to the teachings herein. However, at least two interconnectable segments are required, so that segmented adaptable mobility aid device 1500 is height-adjustable for accommodating the height of user 108 and for ascending or descending stairway 202.

Referring again to FIGS. 15 and 16, at least one of the segments 1510a/1510b/1510c has at least one aperture 1520 for reasons described presently. In this regard, a plurality of pins, such as first pins 1530a, second pins 1530b and third pins 1530c, engage respective ones of apertures 1520 for interconnecting segments 1510a/1510b/1510c and for securing segments 1510a/1510b/1510c against movement relative to each other. Pins 1530a may be spring-loaded, so that pins 1530a can be manipulated by means of a cable and spring arrangement, generally referred to as 1535. Cable and spring arrangement 1535 is described in detail hereinbelow. Pins 1530b and 1530c are manipulated manually rather than by a cable and spring arrangement. More specifically, pins 1530b and 1530c are caused to engage selected ones of apertures 1520 in a manner that adjusts the height of first segment 1510a to the height of second segment 1510b. After pins 1530a and pins 1530b engage their respective apertures 1520, the pins 1530a and 1530b are not subsequently readjusted. In other words, pins 1530a and 1530b are only adjusted once, in the manner described immediately hereinabove. Suitably adjusting the height of first segment 1510a with respect to the height of second segment 1510b, in turn, adjusts previously mentioned support platform 120 to the height of the knee of user 108, so that the knee of user 108 can be comfortably supported by support platform 120. Knee support platform 120 is configured to be mounted on or coupled to first segment 1510a for providing knee support or optionally for providing a seat for user 108. In other words, and as described in more detail hereinbelow, first segment 1510a is configured to receive support platform 120. Support platform 120 is shown in phantom in FIG. 15 for clarity in illustrating the invention.

Still referring to FIGS. 15 and 16, first segment 1510a includes a handle 1540 sized to be gripped by a hand of user 108, so that user 108 can utilize segmented adaptable mobility aid device 1500 to move himself from one stair step (i.e., tread) to another stair step on the previously mentioned stairway 202 (see FIG. 2A). Also, if desired, user 108 can utilize segmented adaptable mobility aid device 1500 to move himself from one location to another location on the previously mentioned inclined walkway 102 (see FIG. 2A).

Referring yet again to FIGS. 15 and 16, handle 1540 of first segment 1510a includes a pair of elongate, parallel handle arms 1550a and 1550b integrally attached to a generally horizontally-oriented handlebar portion 1555. Handlebar portion 1555 has an inverted U-shape configuration, so that a hand of user 108 can easily grasp handle 1540. Handle arms 1550a and 1550b have a first chamber 1560a and a second chamber 1560b extending longitudinally therein, respectively, for reasons provided hereinbelow. First segment 1510a also includes a first pair of elongate, parallel legs 1570a and 1570b disposed generally opposite handle arms 1550a/1550b for reasons provided hereinbelow. A laterally extending first brace 1580a and a laterally extending second brace 1580b are coupled to respective ones of handle arms 1550a and 1550b and respective ones of legs 1570a and 1570b for providing structural rigidity to first segment 1510a, such that handle 1540 and legs 1570a/1570b are maintained in an upright position as segmented adaptable mobility aid device 1500 is utilized by user 108. More specifically, first brace 1580a has a first end 1584a thereof coupled to handle arm 1550a and a second end 1587a thereof coupled to leg 1570a. Similarly, second brace 1580b has a first end 1584b thereof coupled to handle arm 1550b and a second end 1587b thereof coupled to leg 1570b.

As shown in FIGS. 15 and 16, height of segmented adaptable mobility aid device 1500 is adjusted and locked to accommodate the height of user 108. More specifically, second segment 1510b includes a second pair of elongate, parallel legs 1590a and 1590b. As described in more detail momentarily, second pair of legs 1590a and 1590b is configured to slidably receive respective ones of first pair of legs 1570a/1570b. In this regard, second pair of legs 1590a/1590b has a third chamber 1600a and a fourth chamber 1600b longitudinally extending therein, respectively. Also, first pair of legs 1570a/1570b is sized to slidably fit within respective ones of third chamber 1600a and fourth chamber 1600b that are defined by second pair of legs 1590a/1590b. In addition, second pair of legs 1590a and 1590b have lower end portions 1605a and 1605b, respectively, for reasons provided hereinbelow. Previously mentioned apertures 1520 are formed through both second pair of legs 1590a/1590b of second segment 1510b and first pair of legs 1570a/1570b of first segment 1510a, so that, as apertures 1520 are aligned by vertical movement of first segment 1510a relative to second segment 1510b, pins 1530b and 1539c can be manually inserted into apertures 1520. Insertion of pins 1530b and 1530c into their respective apertures 1520 fixes the positions of first segment 1510a and second segment 1510b relative to each other. Moreover, as described in detail hereinbelow, previously mentioned cable and spring arrangement 1535 is utilized by user 108 to insert pins 1530a into apertures 1520 that are formed in support uprights 1610a/1610b (e.g., see FIG. 16).

With reference again to FIGS. 15 and 16, second segment 1510b also comprises a pair of elongate, parallel support uprights 1610a and 1610b that are coupled to respective ones of second pair of legs 1590a and 1590b. In this regard, support uprights 1610a/1610b are coupled to second pair of legs 1590a/1590b by means of a laterally extending third support brace 1620a and a laterally extending fourth support brace 1620b. More specifically, third support brace 1620a and fourth support brace 1620b are coupled to respective ones of support uprights 1610a and 1610b and also coupled to respective ones of second pair of legs 1590a and 1590b for providing structural rigidity to second segment 1510b, such that support uprights 1610a/1610b and legs 1590a/1590b are maintained in an upright position as segmented adaptable mobility aid device 1500 is utilized by user 108. More particularly, third support brace 1620a has a first end 1624a thereof coupled to support upright 1610a and a second end 1624b thereof coupled to leg 1590a. Similarly, fourth support brace 1620b has a first end 1627a (see FIG. 16) thereof coupled to support upright 1610b and a second end 1627b thereof coupled to leg 1590b.

Referring again to FIGS. 15 and 16, support upright 1610a is sized to be slidably received in first chamber 1560a defined by handle arm 1550a and support upright 1610b is sized to be slidably received in second chamber 1560b defined by handle arm 1550b. In addition, support upright 1610a defines a third chamber 1630a therein and support upright 1610b defines a fourth chamber 1630b (see FIG. 16) therein for reasons provided hereinbelow.

As shown in FIGS. 15 and 16, third segment 1510c comprises a third pair of elongate, parallel legs 1640a and 1640b. Third pair of legs 1640a and 1640b have lower end portions 1645a and 1645b, respectively, for reasons provided hereinbelow. Leg 1640a is sized to be slidably received in third chamber 1630a that is defined by support upright 1610a. Leg 1640b is sized to be slidably received in fourth chamber 1630b that is defined by support upright 1610b. In this manner, the sliding engagement of third pair of legs 1640a/1640b of third segment 1510c with respective ones of third chamber 1630a and fourth chamber 1630b defined by support uprights 1610a/1610b of second segment 1510b allow the elevation of third segment 1510c to be slidably and downwardly adjusted relative to second segment 1510b, in the manner described in detail hereinbelow.

As shown in FIGS. 15 and 16, a first footer 1650, which may be a horizontally-extending elongate bar, is coupled to previously mentioned lower end portions 1605a/1605b that belong to respective ones of the pair of second legs 1590a/1590b provided by second segment 1510b. Similarly, a second footer 1670, which may be a horizontally-extending elongate bar, is coupled to previously mentioned lower end portions 1645a/1645b that belong to respective ones of the pair of third legs 1640a/1640b provided by third segment 1510c. First footer 1650 and second footer 1670 provide frictional contact of segmented adaptable mobility aid device 1500 with inclined surface 102 or the steps of stairway 202.

With reference to FIGS. 15 and 16, assembly of segmented adaptable mobility aid device 1500 will now be described. In this regard, support uprights 1610a/1610b are inserted in the direction of directional arrows 1675a/1675b into respective ones of chambers 1560a/1560b as first pair of legs 1570a/1570b are simultaneously inserted in the direction of directional arrows 1680a/1680b into respective ones of chambers 1600a/1600b. Insertion of support uprights 1610a/1610b into respective ones of chambers 1560a/1560b allows first segment 1510a to be mounted onto second segment 1510b. Similarly, third pair of legs 1640a/1640b is inserted in the direction of directional arrows 1685a/1685b into respective ones of chambers 1630a/1630b. Insertion of third pair of legs 1640a/1640b into respective ones of chambers 1630a/1630b allows second segment 1510b to be mounted onto third segment 1510c. As previously indicated, pins 1530a/1530b/1530c are manipulated by user 108, so as to engage their respective apertures 1520 in order to interlock segments 1510a/1510b/1510c. Support platform 120 is mounted onto braces 1580a/1580b, such as in the direction of directional arrow 1690, to provide knee support or optionally to provide a seat for user 108.

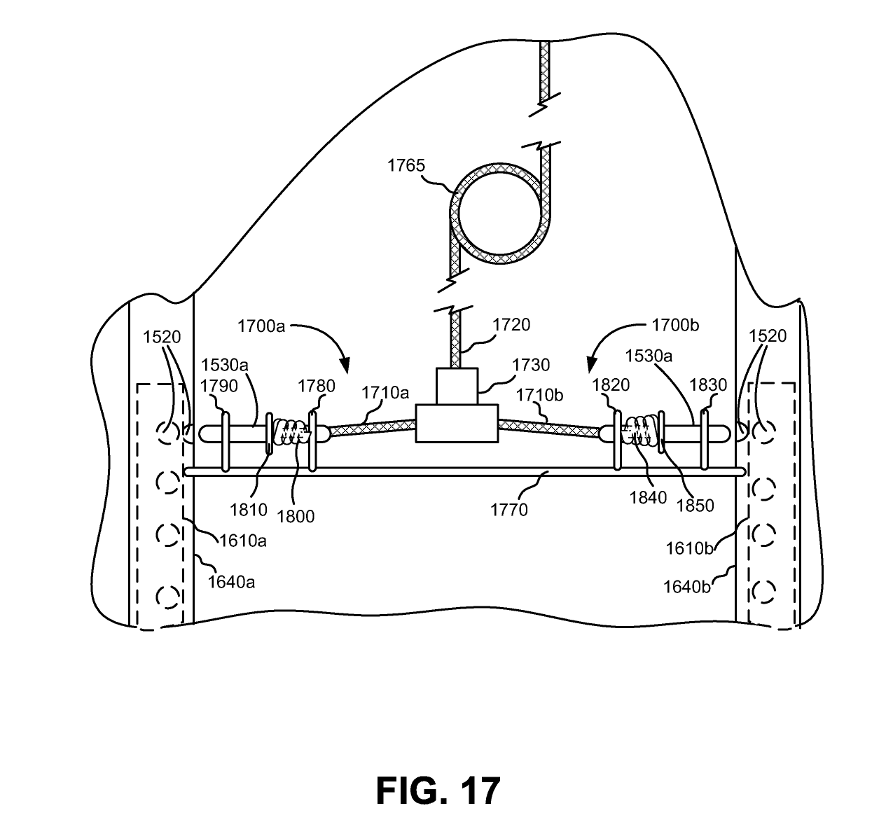

Referring to FIGS. 15, 16 and 17, previously mentioned cable and spring arrangement 1535 for manipulating first pins 1530a will now be described in detail. In this regard, cable and spring arrangement 1535 comprises a left pin and spring arrangement, generally referred to as 1700a, and a right pin and spring arrangement, generally referred to as 1700b. A left cable 1710a is coupled to a leftmost first pin 1530a and a right cable 1710b is coupled to a rightmost first pin 1530a, as shown. Each of cables 1710a/1710b is joined to a main cable 1720 at a junction 1730. Main cable 1720 is, in turn, coupled to a lever mechanism 1740 having an operable lever 1750. Lever mechanism 1740 is coupled either to leg 1550a or leg 1550b, such as by a band or strap 1760 extending around leg 1550a or leg 1550b, as the case may be. User 108 utilizes lever mechanism 1740 to engage pins 1530a into their associated apertures 1520 and to disengage pins 1530a from the apertures 1520. In this regard, user 108 operates or moves lever 1750, such as downwardly moving lever 1750, to tension main cable 1720. As main cable 1720 is tensioned, left cable 1710a and right cable 1710b are simultaneously placed in tension because left cable 1710a and right cable 1710b are joined to main cable 1720 at junction 1730. A portion of main cable 1720 may be in the form of a service loop 1765, if desired, for temporarily allowing slack in main cable 1720 before tensioning of main cable 1720. As described in detail hereinbelow, the configuration and operation of left pin and spring arrangement 1700a and the configuration and operation of right pin and spring arrangement 1700b allow first pins 1530a to engage and disengage apertures 1520 for the reasons provided hereinabove.

Referring again to FIGS. 15, 16 and 17, the configuration and operation of left pin and spring arrangement 1700a is described in detail presently. In this regard, left pin and spring arrangement 1700a that belongs to cable and spring arrangement 1535 includes an attachment bracket 1770, which spans support uprights 1610a/1610b. Attachment bracket 1770 includes a first vertical member 1780 and a second vertical member 1790 for left cable and spring arrangement 1700a. Pin 1530a passes through first vertical member 1780 and second vertical member 1790. Pin 1530a is integrally connected to left cable 1710a at an end portion of pin 1530a. A biasing member, such as a first spring 1800, encircles pin 1530a, and is positioned between first vertical member 1780 and a first washer 1810 that is affixed to pin 1530a. When lever mechanism 1740 is activated by user 108 moving lever 1750, left cable 1710a is drawn away from support upright 1610a. As left cable 1710a is drawn away from support upright 1610a a sufficient distance, pin 1530a is drawn out of aperture 1520, and first washer 1810 compresses first spring 1800 against first vertical member 1780. When lever mechanism 1740 is no longer activated, that is, when user 108 releases lever 1750, the energy stored in compressed first spring 1800 is released, with pin 1530a moving back into aperture 1520. When pin 1530a moves back into aperture 1520, pin 1530a secures leg 1640a against sliding movement within chamber 1630a of support upright 1610a.

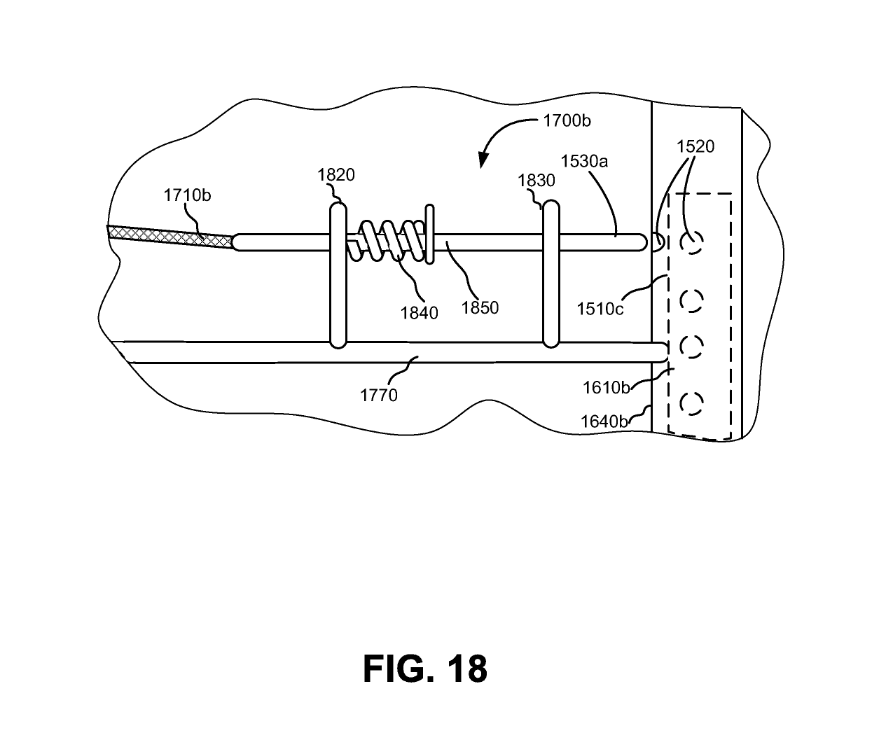

Referring to FIGS. 15, 16, 17 and 18, the configuration and operation of right pin and spring arrangement 1700b is described in detail presently. In this regard, right pin and spring arrangement 1700b that belongs to cable and spring arrangement 1535 includes the attachment bracket 1770, which spans support uprights 1610a/1610b. Attachment bracket 1770 includes a third vertical member 1820 and a fourth vertical member 1830 for right cable and spring arrangement 1700b. Pin 1530a passes through third vertical member 1820 and fourth vertical member 1830. Pin 1530a is integrally connected to right cable 1710b at an end portion of pin 1530a. A biasing member, such as a second spring 1840, encircles pin 1530a, and is positioned between third vertical member 1820 and a second washer 1850 that is affixed to pin 1530a. When lever mechanism 1740 is activated by user 108 moving lever 1750, right cable 1710b is drawn away from support upright 1610b. As right cable 1710b is drawn away from support upright 1610b a sufficient distance, pin 1530a is drawn out of aperture 1520, and second washer 1850 compresses second spring 1840 against third vertical member 1820. When lever mechanism 1740 is no longer activated, that is, when user 108 releases lever 1750, the energy stored in compressed second spring 1840 is released, with pin 1530a moving back into aperture 1520. When pin 1530a moves back into aperture 1520, pin 1530a secures leg 1640b against sliding movement within chamber 1630b of support upright 1610b.

With reference to FIGS. 15, 16, 17 and 18, segmented adaptable mobility aid device 1500 is particularly useful for ascending and descending the steps of stairway 202. In this regard, when user 108 wants to ascend stairway 202, he positions segmented adaptable mobility aid device 1500 in front of the first step of stairway 202. At this point, first pins 1530a, second pin 1530b and third pins 1530c have been previously engaged with their respective apertures 1520, so that segments 1510a/1510b/1510c cannot move relative to each other. Also, at this point, first footer 1650 and second footer 1670 are at the same elevation with respect to each other, with first footer 1650 being positioned above surface 102 and with second footer 1670 being positioned above the first step of stairway 202. User 108 then operates the lever 1750 to release first pins 1530a from their respective apertures 1520 to allow first footer 1650 to drop to surface 102 by force of gravity. After first footer 1650 contacts surface 102, user 108 releases the lever 1750 to reengage pins 1530a with their associated apertures 1520.

It should be appreciated that the adjustment of segmented adaptable mobility aid device 1500 described hereinabove need be made only once when the steps of stairway 202 are the same height. However, segmented adaptable mobility aid device 1500 will require readjustment in the manner described hereinabove when the steps of stairway 202 have different heights.

Thus, it is appreciated from the teachings hereinabove that segmented adaptable mobility aid device 1500 is height-adjustable via use of second pins 1510b and third pins 1510c for accommodating users 108 of various heights. Also, segmented adaptable mobility aid device 1500 can be used to ascend and descend stairway 202 via activation of lever 1750, even when one leg of user 108 is immobile.

A segmented adaptable mobility aid device for use on a level walkway or on stairs has been described. The device has length-adjustable front and rear legs, a handle, and a knee support platform coupled to the legs and the handle, so that lengths of the legs can be adjusted in tandem via single-hand operability of an adjustment mechanism. The legs can be adjusted within a range of lengths suitable for walking on a level or inclined walkway, and for ascending and descending stairs. The segmented adaptable mobility aid device includes a knee support platform that, during stairway use, can straddle or span two steps, to better distribute the user's weight during ascent or descent of stairs. The device also includes an adjustment mechanism that can be activated with a single hand to enable length adjustability of the front legs for conversion between use on a level walkway and use on stairs. Embodiments of the invention provide the benefit of increased usability of the device and increased stability of a user during stairway use. Moreover, embodiments of the invention provide the further benefit of single hand operability of the adjustment mechanism.

Other modifications and implementations will occur to those skilled in the art without departing from the spirit and the scope of the invention as claimed. For example, a plurality of lockable wheels (not shown) may be removably coupled to respective ones of first footer 1650 and second footer 1670 for rolling segmented adaptable mobility aid device 1500 along level or inclined surface 102. Accordingly, the above description is not intended to limit the invention except as indicated in the following claims.

1. A segmented adaptable mobility aid device comprising:
at least three interconnectable segments, each segment having at least one aperture;
a pin engageable with the at least one aperture for interconnecting at least three interconnectable segments, and for securing at least three interconnectable segments against movement relative to each other; and
a support platform configured to be coupled to a predetermined segment of at least three interconnectable segments, the support platform being for providing knee support or for providing a seat.

2. The device of claim 1, wherein at least three interconnectable segments comprises:
a first segment;
a second segment configured to engage the first segment; and
a third segment configured to engage the second segment.

3. The device of claim 2, further comprising a lever mechanism coupled to the third segment for adjusting the height of the third segment to the height of a stair step or to the incline of a ramp.

4. The device of claim 3, wherein the lever mechanism comprises a pin and spring arrangement.

5. The device of claim 2, wherein the first segment is configured to receive the support platform thereon.

6. The device of claim 2, wherein the first segment comprises:
a handle including a pair of handle arms; and
a first pair of legs coupled to respective ones of the pair of handle arms.

7. The device of claim 6, wherein the second segment comprises:
a second pair of legs configured to engage respective ones of the first pair of legs; and
a pair of support uprights coupled to the second pair of legs, and configured to engage respective ones of the pair of handle arms.

8. The device of claim 7, wherein the third segment comprises:
a third pair of legs configured to engage respective ones of the pair of support uprights.

9. The device of claim 8, further comprising:
a first footer coupled to the second pair of legs for stabilizing the second pair of legs on a surface; and
a second footer coupled to the third pair of legs for stabilizing the third pair of legs on the surface.

10. A segmented adaptable mobility aid device comprising:
at least three segments, wherein:
a first of the segments is slideably engaged with a second of the segments,
the second one of the segments is slideably engaged with the first segment and a third one of the segments,
the third one of the segments is slideably engaged with the second segment,
the first segment includes a platform,
the second segment includes a first pair of legs, and
the third segment includes a second pair of legs;
a first means for adjusting and fixing a length of the first pair of legs;
a second means for adjusting and fixing the length of the second pair of legs at a first end of the second pair of legs; and
a third means for adjusting and fixing the length of the second pair of legs at a second end of the second pair of legs,
whereby the height of the platform with respect to the length of the first pair of legs can be adjusted and fixed to accommodate a user using the first and second means for adjusting and fixing, while relative length between the first and second pair of legs can be adjusted independent of the height of the platform using the third means for adjusting and fixing.

11. The segmented adaptable mobility aid device of claim 10, wherein the third means for adjusting and fixing includes a cable coupled to lever mechanism, the lever mechanism being coupled to the first segment.

12. The segmented adaptable mobility aid device of claim 10, wherein the first, second and third means for adjusting and fixing includes a set of pins and a plurality of apertures, the at least three segments being slideably adjustable when the pins are withdrawn from the apertures and refrained from sliding when the set of pins is engaged in any of the apertures.

13. A segmented adaptable mobility aid device comprising:
at least three segments, wherein:
a first of the segments is slideably engaged with a second of the segments,
the second one of the segments is slideably engaged with the first segment and a third one of the segments,
the third one of the segments is slideably engaged with the second segment,
the first segment includes a platform,
the second segment includes a first pair of legs, and
the third segment includes a second pair of legs;
a first pin and aperture adjustment mechanism for adjusting and fixing a length of the first pair of legs;
a second pin and aperture adjustment mechanism for adjusting and fixing the length of the second pair of legs at a first end of the second set of legs; and
a third pin and aperture adjustment mechanism for adjusting and fixing the length of the second pair of legs at a second end of the second pair of legs,
whereby the height of the platform with respect to the length of the first pair of legs can be adjusted and fixed to accommodate a user using the first and second pin and aperture adjustment mechanisms, while relative length between the first and second pair of legs can be adjusted independent of the height of the platform using the third pin and aperture adjustment mechanism.

14. The segmented adaptable mobility aid device of claim 13, wherein the third pin and aperture adjustment mechanism includes a cable coupled between the set of pins and a lever mechanism, the lever mechanism being coupled to the first segment.
